(19) United States
(12) Patent Application Publication
(10) Pub. No.: US 2004/0048754 A1
(43) Pub. Date: Mar. 11, 2004

(54) Compounds for a controlled release of active compounds

(76) Inventors: Andreas Herrmann, Veyrier (CH); Eric Frerot, Ville La Grand (FR)

Correspondence Address: WINSTON & STRAWN, PATENT DEPARTMENT, 1400 L STREET, N.W., WASHINGTON, DC, 20005-3502, US

(21) Appl. No.: 10/652,365

(22) Filed: Aug. 29, 2003

Related U.S. Application Data
(63) Continuation of application No. PCT/IB02/00921, filed on Mar. 25, 2002.

(30) Foreign Application Priority Data
Mar. 27, 2001 (WO) PCT/IB01/00524

(51) Int. Cl. C11D 9/44

(52) U.S. Cl. 510/101

(57) ABSTRACT

The present invention relates to the field of perfumery. More particularly, it concerns a compound having supported carbamoyl/ester moieties which comprise an ester capable of liberating an active compound and, in proximity, a carbamoyl function facilitating the release of the active compound. The present application concerns also the uses of such compounds as active ingredient or as a precursor capable of liberating active alcohols, ketones or aldehydes, as well as compositions comprising such compounds.

### CROSS-REFERENCE TO RELATED APPLICATIONS

This application is a continuation of International application no. PCT/IB02/00921 filed Mar. 25, 2002, the entire content of which is expressly incorporated herein by reference thereto, and claims the benefit of International application no. PCT/IB01/00524 filed Mar. 27, 2001.

### TECHNICAL FIELD

The present invention relates to the field of perfumery. More particularly, it concerns a compound having supported carbamoyl/ester moieties which comprise an ester capable of liberating an active compound and, in proximity, a carbamoyl function facilitating the release of the active compound. The present application concerns also the uses of the compound, as well as the compositions comprising the compounds.

### BACKGROUND

The industry has a particular interest in compounds which are capable of prolonging the effect of active compounds over a certain period of time, for example in order to overcome the problems encountered when using perfuming ingredients which are too volatile. U.S. Pat. No. 5,649,979 in particular discloses compounds which, under certain activation conditions such as the presence of enzymes, in particular lipases, are capable of liberating a fragrance ingredient over an extended period of time. These compounds can have various applications. The washing of textiles is a particular field in which there is a constant quest to enable the effect of perfuming substances to be effective for a certain period after washing and drying. Many substances having fragrances which are particularly suitable for this type of application are, in fact, known to lack tenacity on laundry, or do not remain on the laundry when rinsed, with the result that their perfuming effect is experienced only briefly and not very intensely. Given the importance of this type of application in the perfuming industry, research in this field has been sustained, in particular with the aim of finding new, even more effective solutions to the aforementioned problems.

### SUMMARY OF THE INVENTION

Surprisingly, we have discovered the existence of new compounds based on oligomer or polymer supported carbamoyl/ester moieties which comprise an ester capable of liberating an active compound and, in proximity, a carbamoyl function facilitating the liberation of the active compound without the aid of an external activator, unlike what is described in the prior art. As the term “active” we mean here that the ingredient or substance to which it refers is capable of bringing a benefit or effect into its surrounding environment, and in particular a perfuming, flavoring insect repellent or attractant, bactericide or fungicide effect. For example as “active compound” we mean here an alcohol or a ketone or aldehyde, possibly in the enol form, capable of bringing a benefit or effect into its surrounding environment, and in particular any perfumery, flavor, insect repellent or attractant, bactericide or fungicide alcohol or ketone or aldehyde, these latter being possibly in the enol form.

### DETAILED DESCRIPTION OF THE PREFERRED EMBODIMENTS

The compounds of the present invention have the following formula

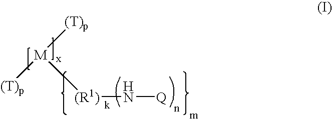

wherein

a) k represents 1 or 0;

b) n represents an integer from 0 to 4;

c) x represents an integer from 1 to 50000;

d) p represents 1 or 0 if x≧2, or 1 if x=1;

e) m represents 1 or 2 if x≧1, an integer from 2 to 4 if x=1, or an integer from 2 to 80 if M represents a dendritic core;

f) R¹ represents a hydrogen atom (in the case where n=0), a multivalent radical (with a n+1 valence) derived from a polypropylene- or a polyethylene-glycol having an average molecular weight comprised between 50 g/mol and 4500 g/mol, or a multivalent radical (with a n+1 valence) derived from a C₁-C₂₂ linear or branched alkyl, alkenyl or alkylbenzene radical, possibly substituted, and the radical may contain in the main chain from 1 to 10 functional groups selected from the group consisting of carbonate ether, ester, ketone, amine, quaternary amines and amides; and with the proviso that at least two R¹ in formula (I) are not a hydrogen atom;

g) Q represents a hydrogen atom or a radical of the formulae

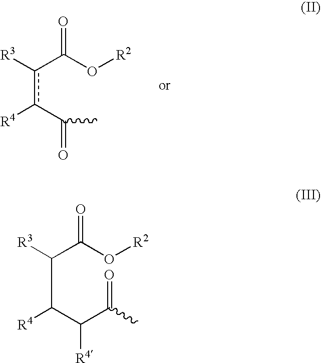

in which the wavy line indicates the location of the bond between the moiety Q and the NH group, the dotted line indicates the location of a single or double bond;

R² represents a radical derived from an active alcohol or enol of the formula R²OH;

R³, R⁴ and R^{4′} represent a hydrogen atom or a C₁ to C₂₀ linear or branched, saturated or unsaturated, radical, optionally substituted with one or more heteroatoms; or the R³, R⁴ and R^{4′}, when considered together with the carbon atoms to which they are bonded, can form aromatic or aliphatic monocyclic, bicyclic or tricyclic groups; and with the proviso that at least two of the Q moieties in formula (I) are not hydrogen atoms;

h) T represents a hydrogen or halide atom, a sulfate or sulfonate group, a C₁ to C₁₀ ester, alkyl, alcoholate or cyanoalkyl group, a carboxylic acid or a N(R⁵)₂ group and the corresponding C, to C₆ alkylated quaternary salts, R⁵ being a hydrogen atom or a C₁-C₁₅ alkyl, alkenyl or aromatic group, the group possibly containing in the main chain from 1 to 5 functional groups selected from the group consisting of ether, ester, ketone, amine, quaternary amines and amides;

i) M represents a dendritic core of zero to 7^{th} generation, a group of the formula A) or yet a “monomeric unit”, of a polymeric chain, selected from the group consisting of the saccharides and the monomeric units of the formulae B) to G) and mixtures thereof

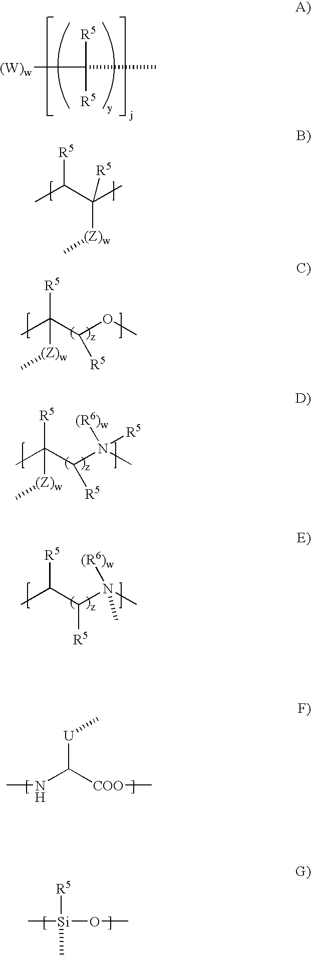

in which formulae A) to G) the hatched lines indicate the location of the bond between the group A) to G) and R¹, R⁵ is defined as previously;

w is equal 1 or 0;

y represents an integer from 1 to 12;

j represents an integer from 2 to 4;

z represents an integer from I to 5;

W represents a nitrogen or carbon atom or a NR⁵, NR⁵₂, O, CO, OC(O)O, C(O)O, C(N)O or NC(O)N functional group;

R⁶ represents a hydrogen or oxygen atom or a C₁-C₅ alkyl or glycol group;

U represents a side chain of an amino acid; and

Z represents a functional group selected from the groups consisting of the functional groups of the formulae i) to x) and the branching units of formulae xi) to xiii) and mixtures thereof:

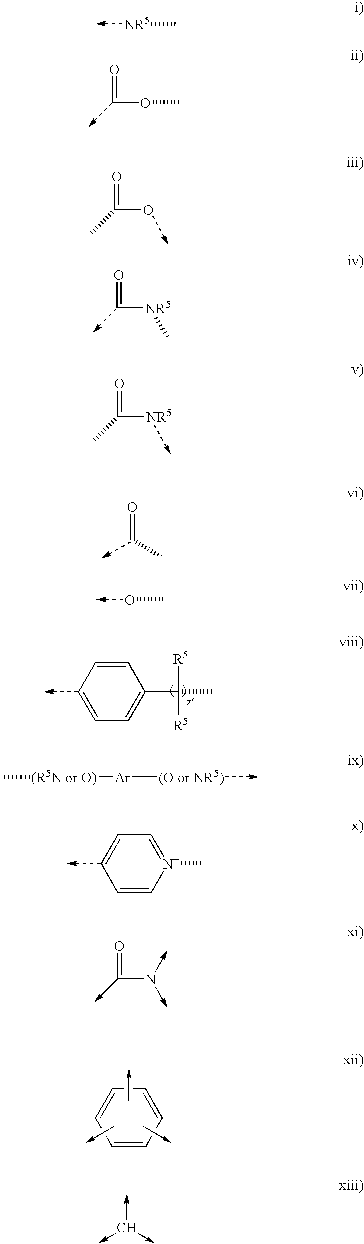

in which formulae the hatched lines being defined as previously, the dotted arrows indicating the location of the bond between the Z and the remaining part of the monomeric unit and the arrows indicating the location of the bond between the Z and either R¹ or the remaining part of the monomeric unit, R⁵ is defined as previously and z¹ is an integer from 0 to 5; with the proviso that Z does not represent a group of formula i), iii), v), vii), and ix) if M represents a group of formula C) or D).

It is understood that whenever in a compound of formula (I) there are more than one Q group, then each the group may be identical or different to the other Q groups. The same applies to the other symbols k, n, m, x, p, M, T, and R¹.

Groups which are possible substituents of R¹, R³, R⁴, R^{4′} or R⁵ are for example hydroxyl groups, alkoxy or polyglycol groups, aromatic or alkylaromatic groups, amines and in particular quaternary ammonium functions, amides, dialkyl amides, SO₃H or OSO₃H groups, N-oxides or carboxylic groups. Preferably, the substituents will be selected from the group comprising polyethylene or propylene glycol, polysaccharides, sulfonates and quaternary ammonium functions, e.g. of formulae xiv) to xvi):

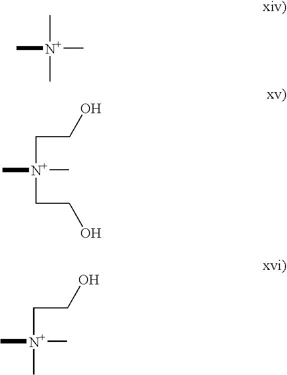

the solid line indicating the bond to the R¹, R³, R⁴, R^{4′} or R⁵ group.

Preferred compounds of formula (I) are those wherein:

k, n, x, p and m are as defined hereinabove;

R¹ represents a multivalent group derived from a polypropylene- or polyethylene-glycol having an average molecular weight of between 50 g/mol and 1200 g/mol, or a linear or branched multivalent C₁₋₁₂ alkyl group, possibly containing in the main chain 1 or 2 functional groups selected in the group consisting of carbonate, ester, ether, carbonyl or amine;

Q represents a group obtained from a phthalic or maleic derivative, optionally substituted, and an active alcohol or enol of the formula R²OH;

T represents a hydrogen atom, a N(R⁵)₂ group, a C₁-C₅ alkyl, alcoholate, cyanoalkyl or ester group, a sulfonate or sulfate group; and

M represents a dendritic core of zero to 5^{th} generation, a saccharide or a “building block” selected in the group consisting of the formulae A), wherein j=2 and W represents an oxygen atom or a NR⁵ or NR⁵₂ group, B), C), E) and F) or mixtures thereof, and in the formulae w, y, z, R⁵, R⁶, U and Z are defined as previously.

More preferably, in the compound of formula (I) k, n, x, p, m, R¹, Q and T are as defined hereinabove and M represents a group selected in the group consisting of:

a dendritic core of zero to 5^{th} generation selected from the group consisting of the polyalkylimine dendrimers, glycoamine dendrimers, amino acids (e.g. lysine) dendrimers, mixed amino/ether dendrimers and mixed amino/amide dendrimers;

a saccharide derivative selected from the group consisting of glucose, glucosoamine, cellulose, amylose, mannuronic or guluronic acid;

a group of formula A) wherein j=2 and W represents an oxygen atom or a NR⁵ or NR⁵₂ group;

a group of formula B) representing an acrylic derivative (e.g. an acrylic acid or an acrylamide derivative) or a styrene derivative (e.g. a vinylbenzyl chloride, a vinylbenzoic acid, or a vinyl aniline derivative);

a group of formula E) representing an ethyleneimine or propyleneimine derivative; and

a group of formula F) representing a lysine, a serine, a threonine or a tyrosine; and in which formulae A), B) and E) the symbols R⁵, R⁶, w, and y are as defined previously and R⁵ represents a hydrogen atom or a C₁-C₃ group.

Other more preferred compounds of the formula (I) are those wherein Q is defined as hereinabove and the (T)ₚ-[M-((R¹)ₖ—(NH)ₙ)ₘ]ₓ-(T)ₚ moiety represents a group derived from one of the compounds selected in the group consisting of:

a polyamidoamine dendrimer, a polyalkylamine dendrimer, more preferably a polypropyleneimine dendrimer such as those available under the tradename PAMAM Starburst® from Dendritech Inc. or ASTRAMOL® from DSM;

a chitosan, a polyamino alginate or cellulose, a cyclodextrine or a starch derivative containing at least two NH₂ groups, such as those commercially available from the company Carbomer;

a polyalkyleneimine such as the polyethyleneimine commercially available under the tradename Lupasol® from BASF, Sternamines® from Clariant or Jeffamine® from Mitsibushi; and

a polylysine such as poly-DL-Lysine; and in which moiety (T)ₚ-[M-((R¹)ₖ—(NH)ₙ)ₘ]ₓ-(T)ₚ the indexes k, n, x, p and m are as defined hereinabove.

Furthermore, the compounds of the invention wherein Q, R¹, k, n, x, p and m are as defined previously and the (T)ₚ-[M]ₓ-(T)ₚ moiety represents a group derived from one of the compounds selected in the group consisting of a polystyrene, a cross-linked polystyrene such as the Merrifield resin, or a polymer based on acrylic or methacrylic acid, or on a acrylic or methacrylic ester of a C₁ to C₄ alcohol are also more preferred. Alternatively the (T)ₚ-[M]ₓ-(T)ₚ moiety represents a polymer derived from cellulose or an amino acid such as a natural fiber based on cellulose or an amino acid, e.g. cotton, linen, silk, viscose or paper.

The compounds of formula (I) can be synthesized from commercially available compounds by conventional methods. Generally speaking, the compounds of the invention are susceptible of being obtainable by a process comprising the following steps:

a) reacting a diacid or an anhydride, such as a phthalic, succinic, maleic or glutaric anhydride or acid, with an active compound of formula R²OH to form a derivative containing an ester bond and a carboxylic acid function;

b) converting the carboxylic acid function obtained in step a) into an acyl chloride or fluoride or into a mixed anhydride; and

c) reacting the derivative obtained in step b) with the primary amino function of a compound of formula T-[M-(R¹)ₖ—(NH₂)ₙ)ₘ]ₓ-T, as defined hereinabove; or alternatively

d) reacting the derivative obtained in step b) with the primary amino function of a monomeric precursor of the polymeric back-bone M, as defined hereinabove; and

e) polymerizing, according to any standard method, the compound obtained in step d).

An example of this approach is illustrated in the following scheme:

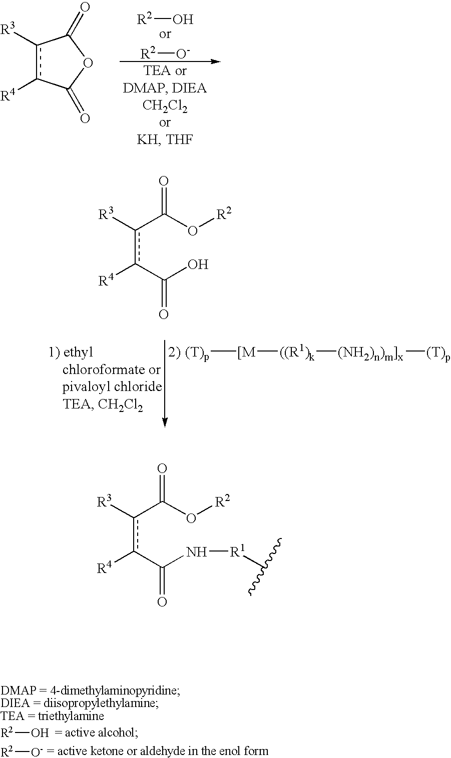

The compounds of the invention are composed of two main parts, the carrier moiety (T)ₚ-[M-((R¹)ₖ)ₘ]ₓ-(T)ₚ and the release moiety NHQ.

The carrier moiety (T)ₚ-[M-((R¹)ₖ)ₘ]ₓ-(T)ₚ plays essentially the role of support to which are attached several releasing units NHQ; however, in the case where the compounds of the invention are intended for an application implying their deposition on a surface, the carrier moiety can also play an important role in the effective deposition and surface substantivity of the compounds of formula (I), especially on fabrics. The role in the effective deposition depends on the specific chemical nature of carrier moiety and is well known by a person skilled in the art.

The nature of R¹ plays also an important role in the fine-tuning of the release kinetics of the active compound R²OH, e.g. an alcohol. Generally, primary alcohols are more rapidly released than secondary or tertiary alcohols; however, with a suitable choice of R¹, the speed of the active alcohol release can be influenced considerably. Indeed the release of R²OH will be carried out more or less rapidly as a function of the chain length, the number of heteroatoms on the main chain, or the degree of branching of the R¹ group.

The special feature of the invention resides in the structure of the release moiety NHQ. Thanks to the particular structure, the hydrolysis of the ester group, which causes liberation of the active compound, is assisted by the nucleophilic group adjacent to the ester function, the CONH—R¹ group. This assistance has a completely unexpected advantage, i.e. it permits the cleavage of the ester bond by hydrolysis under neutral or alkaline conditions, as shown by the following scheme:

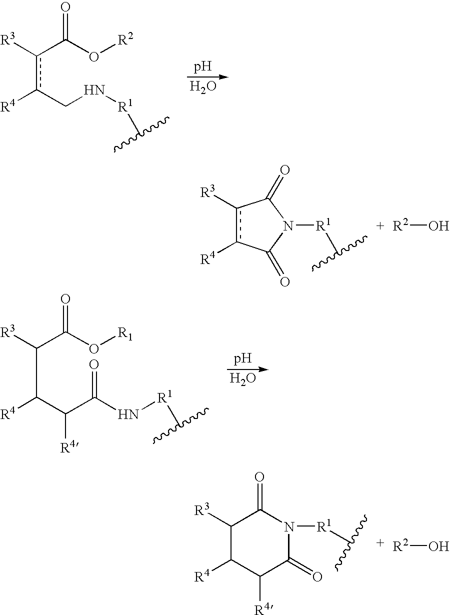

Such pH changes are, for example, the normal conditions for a washing cycle of textiles, wherein the pH may change from a value corresponding to an acid medium to values corresponding to a neutral or even basic medium during the course of the washing cycle, thus allowing the compounds according to the invention to undergo the hydrolysis process.

Furthermore, the reaction may be catalyzed naturally in the presence of heat. This is the case for example when laundry is dried, in particular in an electric dryer, or ironed, especially steam ironed. The hydrolysis reaction leads to the liberation of an active compound R²OH, in which R² has the meaning indicated hereinabove, and a residue of the initial precursor, an imide. The residue being generally, and preferably, inactive, i.e. odorless in the case R²OH is a perfuming compound.

The reaction does not require any other external agent such as the presence of a lipase as described in the prior art.

As mentioned above, the compounds of the invention are capable of releasing odoriferous compounds of formula R²OH, i.e. perfumery alcohols or enols resulting from the ketones or aldehydes commonly used in perfumery. Although it is not possible to provide an exhaustive list of the currently known odoriferous compounds of the formula R²OH usable according to the invention, the following can be named as examples:

a) as alcohols: eugenol, 2-cyclohexyl-1-propanol, 1-decanol, geraniol, nerol, 3,7-dimethyl-1-octanol, citronellol, 1-dodecanol, ethyl vanilline, 2-ethyl-1-hexanol, 1-hexanol, pipol, vegetol, 4-hydroxy-3-methoxybenzaldehyde (vanillin), 4-(4-hydroxy-1-phenyl)-2-butanone (raspberry ketone), 7-p-menthan-1-ol (Mayol®; origin: Firmenich SA, Geneva, Switzerland), anisic alcohol, guaiacol, 2-methoxy-2-phenyl-1-ethanol, isoeugenol, cyclomethylene citronellol, 2-methyl-4-phenyl-1-pentanol, 2-methyl-5-phenyl-1-pentanol, 3-methyl-5-phenyl-1-pentanol, 6-nonen-1-ol, 2,6-nonadien-1-ol, 1-octanol, 2-phenoxy-1-ethanol, 1-phenyl-1-ethanol, 2-phenyl-1-ethanol, 2-phenyl-1-propanol, 3-phenyl-1-propanol, cinnamic alcohol, salicylates, 2,4,6-trimethyl-3-cyclohexene-1-methanol, farnesol, 3,5,5-trimethyl-1-hexanol, 1-undecanol, 10-undecen-1-ol, patchone, 2-tert-butyl-4-methyl-1-cyclohexanol (rootanol), 6,8-dimethyl-2-nonanol, 4,8-dimethyl-7-nonen-2-ol, (E)-3,3-dimethyl-5-(2′,2′,3′-trimethyl-3′-cyclopenten-1′-yl)-4-penten-2-ol (Polysantol®; origin: Firmenich SA, Geneva, Switzerland), ethyl 3-hydroxy hexanoate, 5-ethyl-2-nonanol, dartanol, 3-hydroxy-2-butanone, 1-(4-isopropyl-1-cyclohexyl)-1-ethanol, menthol, 8-p-menthen-2-ol, isopulegol, 7-methoxy-3,7-dimethyl-2-octanol, 2-methoxy-4-propyl-1-cyclohexanol (Tarragol®; origin: Firmenich SA, Geneva, Switzerland), 4-methyl-3-decen-5-ol (origin: Givaudan SA, Geneva, Switzerland), 1-(4-methylphenyl)-1-ethanol (methyl paratolyl carbinol), 4-methyl-1-phenyl-2-pentanol, 1,2,3,4,4a,5,8,8a-octahydro-2,2,6,8-tetramethyl-1-naphthalenol, 3-methyl-5-(2,2,3-trimethyl-3-cyclopenten-1-yl)-2-pentanol (origin: Givaudan SA, Geneva, Switzerland), 2-octanol, 3-octanol, 1-octen-3-ol, 3,4,5,6,6-pentamethyl-2-heptanol (kohinol), 2-pentyl-1-cyclopentanol (cyclopentol), 4-phenyl-2-butanol, 4-phenyl-3-buten-2-ol, 1-phenyl-2-hexanol, 1-phenyl-2-pentanol, 1-phenyl-2-propanol, limbanol, fenchol, borneol, 3-(5,5,6-trimethyl-bicyclo[2.2.1 ]hept-2-yl)-1-cyclohexanol (Sandela®; Givaudan), vebanol, 4-(2,6,6-trimethyl-1-cyclohexen-1-yl)-3-butenol (beta-ionol), alpha-ionol, norlimbanol, 2-undecanol, 3-benzyl-3-pentanol, 4-cyclohexyl-2-methyl-2-butanol (origin: Firmenich SA, Geneva, Switzerland), 2,6-dimethyl-2-heptanol, ethyl linalool, 3,7-dimethyl-1,6-octadien-3-ol (linalool), 3,7-dimethyl-3-octanol (tetrahydrolinalool), 2,6-dimethyl-2-octanol (tetrahydromyrcenol), 2,6-dimethyl-7-octen-2-ol (dihydromyrcenol), hydroxycitronellal, 8-p-menthanol, terpinenol, alpha-terpineol, methyl-4-phenyl-2-butanol, 2-methyl-1-phenyl-2-propanol, 2-(4-methylphenyl)-2-propanol, perhydro-4,8a-dimethyl-4a-naphthalenol (geosmin), tetrahydro-2-isobutyl-4-methyl-4(2H)-pyranol (Florol®; origin: Firmenich SA, Geneva, Switzerland), linalyl oxide, 2,6,10,10-tetramethyl-1-oxaspiro[4.5]decan-6-ol (spiranol), 2,6,6,8-tetramethyl-tricyclo[5.3.1.0(1,5)]undecan-8-ol (cedrenol), nerolidol and pinanol;

b) as aldehydes susceptible to provide the enol: citral, citronellal, campholenic aldehyde, cinnamic aldehyde, hexylcinnamic aldehyde, formyl pinane, hydroxycitronellal, cuminic aldehyde, vanilline, ethyl vanilline, Lilial® [3-(4-tert-butylphenyl)-2-methylpropanal; origin: Givaudan-Roure SA, Vernier, Switzerland], Lyral® [4- and 3-(4-hydroxy-4-methylpentyl)-3-cyclohexene-1-carbaldehyde; origin: International Flavors and Fragrances, USA], Bourgeonal® [3-(4-tert-butylphenyl)propanal; origin: Quest International, Naarden, Netherlands], heliopropanal [3-(1,3-benzodioxol-5-yl)-2-methylpropanal; origin: Firmenich SA, Geneva, Switzerland], Zestover (2,4-dimethyl-3-cyclohexene-1-carbaldehyde; origin: Firmenich SA, Geneva, Switzerland), Trifernal® (3-phenylbutanal; origin: Firmenich SA, Geneva, Switzerland), α-sinensal, (4-methylphenoxy)acetaldehyde, 1,3-benzodioxol-5-carboxaldehyde (heliotropine), Scentenal® [8(9)-methoxy-tricyclo[5.2.1.0.(2,6)]decane-3(4)-carbaldehyde; origin: Firmenich SA, Geneva, Switzerland], Liminal® [(4R)-1-p-menthene-9-carbaldehyde; origin: Firmenich SA, Geneva, Switzerland], Cyclosal [3-(4-isopropylphenyl)-2-methylpropanal; origin: Firmenich SA, Geneva, Switzerland], ortho- and para-anisaldehyde, 3-methyl-5-phenylpentanal, Acropal® [4-(4-methyl-3-pentenyl)-3-cyclohexene-1-carbaldehyde; origin: Givaudan-Roure SA., Vernier, Switzerland], Intreleven® aldehyde (mixture of 10-undecenal and 9-undecenal; origin: International Flavors & Fragrances, USA), muguet aldehyde [(3,7-dimethyl-6-octenyl)acetaldehyde; origin: International Flavors & Fragrances, USA], 2,6-dimethyl-5-heptanal, Precyclemone® B [1-methyl-4-(4-methyl-3-pentenyl)-3-cyclohexen-1-carbaldehyde; origin: International Flavors & Fragrances, USA] and Isocyclocitral® (2,4,6-trimethyl-3-cyclohexene-1-carbaldehyde; origin: International Flavors & Fragrances, USA);

c) as ketones susceptible to provide the enol: camphor, carvone, menthone, ionones, irones, damascenones and damacones, benzyl acetone (4-phenyl-2-butanone), 1-carvone, 4-(4-hydroxy-1-phenyl)-2-butanone (raspberry ketone), Hedione® (methyl dihydrojasmonate; origin: Firmenich SA, Geneva, Switzerland), Neobutenone [1-(5,5-dimethyl-1-cyclohexen-1-yl)-4-penten-1-one; origin: Firmenich SA, Geneva, Switzerland], Calone200 (7-methyl-2H,4H-1,5-benzodioxepin-3-one; origin: C.A.L. SA, Grasse, France), Sulfox [(1R,4R)-8-mercapto-3-p-menthanone; origin: Firmenich SA, Geneva, Switzerland], Orivone® [4-(1,1-dimethylpropyl)-1-cyclohexanone; origin: International Flavors & Fragrances, USA], Delphone (2-pentyl-1-cyclopentanone; origin: Firmenich SA, Geneva, Switzerland), 2-naphthalenyl-1-ethanone, Veloutone (2,2,5-trimethyl-5-pentyl-1-cyclopentanone; origin: Firmenich SA, Geneva, Switzerland), 4-isopropyl-2-cyclohexen-1-one, Iso E Super® [isomer mixture of 1-(octahydro-2,3,8,8-tetrame-2-naphthalenyl)-1-ethanone; origin: International Flavors & Fragrances, USA], Plicatone [5-methyl-exo-tricyclo[6.2.1.0(2,7)]undecan-4-one; origin: Firmenich SA, Geneva, Switzerland]; and macrocyclic ketones such as, for example Exaltone® (cyclopentadecanone), Delta-Muscenone (mixture of 3-methyl-4-cyclopentadecen-1-one and 3-methyl-5-cyclopentadecen-1-one) and muscone (3-methyl-1-cyclopentadecanone), all from Firmenich SA, Geneva, Switzerland.

The compounds according to the invention have proved to be advantageous precursors of active compounds, and in particular of fragrance ingredients. Their main advantage, as previously mentioned, is that on the one hand, they do not need an external agent and, on the other hand, the hydrolysis reaction of the ester bond, as mentioned hereinabove, can also be controlled from the kinetic point of view through the choice of the group R¹. These behaviors enable the system according to the invention to be adapted to the requirements of several possible applications and therefore represents an indisputable advantage.

Furthermore, these compounds have, generally, excellent staying-power or tenacity on a surface, especially on laundry, making them very suitable precursors in particular for applications associated with functional perfumery. Perfuming ingredients present as such in products such as washing powders or detergents can have little staying-power and be consequently often eliminated in the rinsing water during machine washing for example. Conversely, the compounds according to the invention, owing to their substantivity and the controlled liberation of the odoriferous compound, can impart a fragrance and a freshness to laundry which will last well beyond the rinsing and drying processes.

Therefore, the compound of formula (I) might be advantageously associated with compositions intended for perfuming applications. Consequently, the perfuming compositions or perfumed articles comprising a compound of formula (I) are also embodiments of the present invention.

Thus, the compounds according to the invention can be employed for any application requiring the effect of rapid or prolonged liberation of an odoriferous component as defined hereinabove. They can be used in particular in functional perfumery, particularly applications such as liquid or solid detergents for the treatment of textiles and/or in fabric softeners. One of the chief advantages of the invention resides in the fact that the compounds impart an intense fragrance to the laundry, produced by an odoriferous compound, which would not be detected on the laundry over a sufficiently long period if the alcohol had been used as it is, i.e. without a precursor.

The compounds according to the invention can be used as perfuming ingredients for laundry in all types of compositions, e.g. detergent or softening bases. If necessary, in some of the more aggressive media, for example basic media such as detergents, the compound of formula (I) may have to be protected from premature decomposition, for example by encapsulation.

Preferred perfuming compositions or perfumed articles are the fabric softeners, having a pH less than 7, in which these compounds are more stable.

Typical examples of fabric detergents or softener compositions into which the compounds of the invention can be incorporated are described in WO 97/34986, for the former, or in U.S. Pat. Nos. 4,137,180 and 5,236,615 or EP 799 885, for the latter. Other typical detergent and softening compositions which can be used are described in works such as Ullman's Encyclopedia of Industrial Chemistry, vol. A8, pages 315-448 (1987) and vol. A25, pages 747-817 (1994); Flick, Advanced Cleaning Product Formulations, Noye Publication, Park Ridge, N.J. (1989); Showell, in Surfactant Science Series, vol. 71: Powdered Detergents, Marcel Dekker, New York (1988); Proceedings of the World Conference on Detergents (4th, 1998, Montreux, Switzerland), AOCS print.

Naturally, the use of the compounds according to the invention is not limited to the products mentioned hereinabove. These compounds lend themselves equally well to all the other uses common in perfumery, namely the perfuming of soaps and shower or bath gels, after-shaves, hygiene products or hair care products such as shampoos or conditioner, as well as deodorants and air fresheners and also cosmetic preparations.

The compounds can also be used in applications such as detergent compositions or cleaning products for washing up or for cleaning various surfaces, whether they are intended for domestic or industrial use.

In these applications, they can be used alone, mixed together or mixed with other perfuming ingredients, solvents or additives commonly used in perfumery. The nature and type of these co-ingredients do not warrant a more detailed description here, which in any case would not be exhaustive, the skilled person being able to select them on the basis of his general knowledge and according to the nature of the product to be perfumed and the desired olfactory effect. These perfuming ingredients belong to chemical classes as varied as alcohols, aldehydes, ketones, esters, ethers, acetates, nitrites, terpene hydrocarbons, nitrogenous or sulfurous heterocyclic compounds and essential oils of natural or synthetic origin. Many of these ingredients are in any case listed in reference texts such as the book by S. Arctander, Perfume and Flavor Chemicals, 1969, Montclair, N.J., USA, or more recent versions thereof, or in other similar books, or yet in the specialized patent literature commonly available in the art.

The proportions in which the compounds according to the invention can be incorporated into the various aforementioned products vary within a wide range of values. These values are dependent on the nature of the article or product to be perfumed and on the desired olfactory effect as well as the nature of the co-ingredients in a given composition when the compounds according to the invention are mixed with perfuming co-ingredients, solvents or additives commonly used in the art.

For example, typical concentrations are in the order of 0.1% to 10% by weight, or even more, of these compounds based on the weight of the composition into which they are incorporated. Concentrations lower than these can be used when these compounds are applied directly in the perfuming of the various consumer products mentioned hereinabove.

Although special mention has been made hereinabove of the perfuming effect that can be exerted by the invention compounds, the same principles apply to analogous compounds of the invention aimed for the release of flavoring or sanitizing compounds, the perfuming compound being then replaced by a flavoring or sanitizing compound. By the term “sanitizing compound”, we refer here to those substances which can exert an attractant or repellent effect towards certain species of insects, for instance towards houseflies or mosquitoes, or else, or which can have a fungicide, a bactericide or a bacteriostatic activity. It is therefore possible to have flavoring, insect repellent or attractant, bactericide or fungicide precursors of the formula (I), or yet compositions, products or articles containing them. In these applications, they can be used alone, mixed together or mixed with other active ingredients, solvents or additives commonly used in the respective art.

It goes without saying that mixtures of such agents can also be used.

The invention also relates to a process for intensifying or prolonging the diffusion effect of an active compound in a surface, characterized in that the surface is contacted with a compound of formula (I). Preferably the surface is a textile and the compound of formula (I) is contained in a detergent and/or a fabric softener.

Yet another object of the invention is the use of a compound of formula (I) as an active ingredient, e.g. perfuming ingredient, or as a precursor capable of liberating an active alcohol, ketone or aldehyde or a mixture thereof.

Apart from the above-mentioned applications and methods of use, some of the compounds of formula (I) may also be used as active fibers, which are useful for the manufacture of, for example, active papers or cloths. As “active fiber” we mean here a fiber capable of bringing a benefit or effect into its surrounding environment, and in particular a perfumery, insect repellent or attractant, bactericide or fungicide form.

Indeed, this is the case when the (T)ₚ-[M]ₓ-(T)ₚ moiety represents a polymer or a fiber derived from cellulose or an amino acid, e.g. cotton, linen, silk, viscose or paper. In such a case, the active compound precursor is the fiber itself in which the (R₁)ₖ(NHQ)ₙ moiety is chemically bonded. The fiber is therefore able to impart the desired benefit without any additional treatment such as a washing cycle, as it is the case in the above-mentioned application in detergents.

The active compound R²OH can be thus liberated upon use of the fabrics, and for example counteract unpleasant odors such as perspiration. Such fabrics or papers may also be useful as, e.g., ambient air-fresheners or insect repellent or attractant pads.

### EXAMPLES

The invention will now be described in further detail by way of the following examples, wherein the abbreviations have the usual meaning in the art, the temperatures are indicated in degrees centigrade (° C.) ; the NMR spectral data were recorded in CDCl₃ at 360 MHz for ¹H and at 90.6 MHz for ¹³C (if not stated otherwise), the chemical displacement δ is indicated in ppm with respect to TMS as standard, the coupling constants J are expressed in Hz and all the abbreviations have the usual meaning in the art. UV/Vis spectra were recorded on a Perkin-Elmer Lambda 14 instrument, IR spectra on a Perkin Elmer 1600 FTIR spectrometer.

Commercially available reagents and solvents were used without further purification if not stated otherwise. Reactions were carried out in standard glassware under N₂. Column chromatography: Silica gel 60 A (35-70 microns) from SDS. HPLC analyses were carried out on a Thermo Separation Products apparatus consisting of an online vacuum degasser, a SpectraSystem P4000 quaternary pump, a SpectraSystem AS3000 autosampler thermostatted at 20° C. and a SpectraSystem UV6000LP diode array detector coupled with a SEDERE Sedex 55 evaporative light scattering detector. The amount of free NH₂ groups (in mmol/g of resin) of the unmodified and modified polymers described below was determined using the Gisin test described in the literature (B. F. Gisin, Anal. Chim. Acta 1972, 58, 248-249). Dendrimers and their derivatives are named according to G. R. Baker and J. K. Young in Advances in Dendritic Macromolecules, Vol. 1, 1994, G. R. Newcome (Ed.), JAI Press Inc., Greenwich, Conn., USA.

### Example 1

Preparation of (6E,11Z,19Z,24E)-2,6,25,29-tetramethyl-9,22-dioxa-14,17-diaza-2,6,11,19,24,28-triaconta-hexaene-10,13,18,21-tetrone

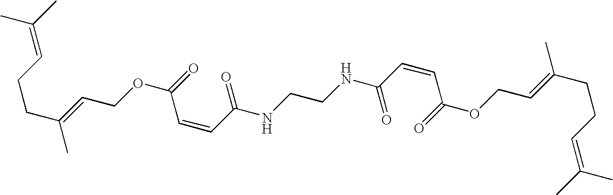

Geraniol (3.08 g, 20 mmol) and maleic anhydride (1.98 g, 20 mmol) were dissolved in 40 ml of CH₂Cl₂. Triethylamine (3 ml, 20 mmol) was added and the reaction was stirred overnight at room temperature. The monogeranyl maleate which was formed was used as such in the next step. Triethylamine (3 ml, 20 mmol) was added to the reaction mixture and the temperature was lowered to −20° C. Pivaloyl chloride (2.66 g, 22 mmol) was added dropwise and the reaction was stirred for 2 h at room temperature. 1,2-Ethylene diamine (0.70 ml, 10 mmol) in 20 ml of CH₂Cl₂ was added dropwise during 45 minutes. The reaction was stirred for another 3.5 h. Then, the resulting solution has been acidified using an aqueous solution of KHSO₄ (5%). The organic phase was washed with water 3 times, dried over Na₂SO₄ and concentrated. Column chromatography (SiO₂, cyclohexane/ethyl acetate 3:7) gave 1.43 g (yield=14%) of an oil.

IR (neat, cm⁻¹): 3281 (m), 3091 (w), 2962 (w), 2913 (m), 2874 (w), 2849 (w), 1724 (s), 1669 (m), 1654 (m), 1630 (m), 1566 (s), 1455 (m), 1438 (m), 1401 (m), 1375 (m), 1315 (w), 1266 (s), 1243 (w), 1225 (s), 1164 (s), 1108 (m), 1067 (w), 1010 (m), 990 (m), 957 (m), 882 (m), 836 (m), 821 (w), 802 (m), 768 (m), 730 (m), 691 (m), 653 (m).

¹H-NMR: 7.65 (s, 2 H); 6.44 (d, J=12.5, 2 H); 6.06 (d, J=12.5, 2 H); 5.32 (t, J=7.1, 2 H); 5.07 (m, 2 H); 4.62 (d, J=7.1, 4 H); 3.56 (d, br., 4 H); 2.14−2.02 (m, 8 H); 1.70 (s, 6 H); 1.68 (s, 6 H); 1.60 (s, 6 H).

¹³C-NMR: 165.6 (s); 143.4 (s); 138.8 (d); 132.0 (s); 124.1 (d); 123.6 (d); 117.3 (d); 62.2 (t); 39.6 (t); 39.0 (t); 29.3 (t); 25.7 (q); 17.7 (q); 16.5 (q).

MS (ESI): 551 ([M+Na]⁺, 100).

### Example 2

a) Preparation of 1-benzylbutyl hydrogen phthalate

4.85 g (32.7 mmol) of phthalic anhydride were added in portions into 70 ml of CH₂Cl₂ containing 5.38 g (32.7 mmol) of 1-phenyl-2-pentanol, 0.40 g (3.3 mmol) of 4-dimethylaminopyridine (DMAP) and 4.23 g (3.3 mmol) of diisopropylethylamine (DIEA). The reaction mixture was left stirring at room temperature for 24 h, then poured onto 100 ml of aqueous KHSO₄ (5%), and extracted with 50 ml of aqueous KHSO4 (5%) and 3 times with 50 ml of brine. The organic phase was dried over Na₂SO₄ and concentrated to give 9.94 g (yield=97%) of a slightly yellow oil, which slowly crystallizes.

IR (neat, cm⁻¹): 3060 (w), 3030 (w), 2960 (m), 2931 (m), 2903 (m), 2871 (m), 2662 (m), 2541 (m), 1726 (s), 1685 (s), 1599 (m), 1578 (m), 1492 (m), 1454 (m), 1436 (m), 1412 (m), 1350 (m), 1282 (s), 1256 (s), 1200 (m), 1170 (w), 1146 (m), 1119 (s), 1073 (s), 1059 (m), 1038 (m,) 1014 (m), 985 (m), 950 (s), 872 (w), 848 (w), 836 (w), 824 (m), 801 (m), 777 (m), 748 (m), 731 (s), 690 (s), 682 (s).

¹H-NMR: 10.64 (br., 1 H); 7.91−7.84 (m, 1 H); 7.58−7.43 (m, 3 H); 7.33−7.17 (m, 5 H); 5.40−5.30 (m, 1 H), 3.06 (ABX, J=13.9, 6.7, 1 H); 2.90 (ABX, J=13.5, 6.7, 1 H); 1.74−1.25 (m, 4 H); 0.89 (t, J=7.3, 3 H).

¹³C-NMR: 172.4 (s); 167.7 (s); 137.5 (s); 133.9 (s); 132.1 (d); 130.6 (d); 129.8 (d); 129.7 (s); 129.5 (d); 129.4 (d); 128.6 (d); 128.4 (d); 126.5 (d); 76.6 (d); 40.2 (t); 35.3 (t); 18.6 (t), 13.9 (q).

MS (EI): 313 ([M+H]⁺, 0.4), 167 (13), 150 (9), 149 (100), 147 (11), 146 (84), 121 (10), 117 (31), 115 (3), 105 (5), 104 (18), 103 (3), 93 (11), 92 (49), 91 (28), 77 (4), 76 (3), 65 (13), 55 (7), 41 (3), 39 (4).

b) Preparation of(±)-bis(1-benzylbutyl)2,2′-(6-methyl-1,11-dioxo-2,6,10-triazaundecane-1,11-diyl)dibenzoate

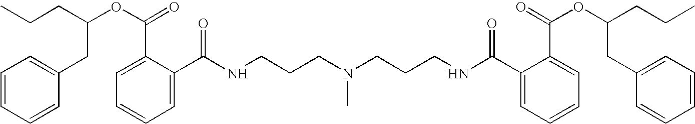

A solution of 1.00 g (3.2 mmol) of 1-benzylbutyl hydrogen phthalate and 0.65 g (6.4 mmol) of triethylamine in 10 ml of CH₂Cl₂ was cooled to 0° C., before 0.35 g (3.2 mmol) of ethyl chloroformate in 5 ml of CH₂Cl₂ were added dropwise during 5 minutes. The reaction mixture was left stirring at 0° C. for 10 minutes and then 0.21 g (1.4 mmol) of 3,3′-methylamino-bis(propanamine) in 5 ml of CH₂Cl₂ were added. Finally, another 0.05 g (0.5 mmol) of ethyl chloroformate in 2 ml of CH₂Cl₂ were added after 10 min followed by 0.12 g (1.3 mmol) of N,N-dimethylethylenediamine in 3 ml of CH₂Cl₂ 15 min later. The mixture was kept stirring for 15 min at 0° C., then poured into 50 ml of aqueous KHSO₄ (5%) and ice and extracted with 50 ml of CH₂Cl₂. The organic phase was washed 10 times with 50 ml of aqueous KHSO₄ (5%), dried over Na₂SO₄, filtered, concentrated and dried under high vacuum to give 1.11 g (yield=99%) of a white solid.

UV/Vis (water/acetonitrile 2:1): 305 (sh, 200), 282 (sh, 1600), 275 (1900), 268 (1900), 264 (1900).

IR (neat, cm⁻¹): 3275 (m), 3060 (w), 3026 (w), 2955 (w), 2928 (w), 2866 (w), 1771 (w), 1712 (m), 1650 (m), 1595 (m), 1579 (m), 1538 (m), 1494 (w), 1482 (m), 1463 (m), 1453 (m), 1396 (w), 1362 (w), 1287 (m), 1261(m), 1161 (w), 1126 (m), 1078 (m), 1045 (m), 1028 (m), 962 (w), 944 (w), 849 (w), 782 (w), 737 (m), 699 (m).

¹H-NMR: 7.86 (m, 2 H); 7.57−7.45 (m, 4 H); 7.40−7.12 (m, 14 H); 5.26−5.15 (m, 2 H); 3.48−3.28 (m, 4 H); 3.27−3.12 (m, 1 H); 3.05−2.83 (m, 3 H); 3.01 (ABX, J=13.5, 5.9, 2 H); 2.87 (ABX, J=13.5, 6.3, 2 H); 2.55 (s, 3 H); 2.08−1.90 (m, 4 H); 1.68−1.20 (m, 8 H); 0.87 (t, J=7.3, 6 H).

¹³C-NMR: 169.4 (s); 167.0 (s); 137.6 (s); 137.4 (s); 131.3 (s); 131.1 (d); 129.6 (d); 129.5 (d); 129.0 (d); 128.542 (d); 128.4 (d); 128.0 (d); 126.4 (d); 75.8 (d); 53.9 (t); 40.2 (t); 39.7 (q); 36.5 (t); 35.4 (t); 23.7 (t); 18.6 (t); 14.0 (q).

MS (EI): 121 (4), 103 (6), 93 (9), 92 (100), 91 (46), 77 (6), 73 (6), 71 (3), 70 (6), 65 (11), 61 (5), 57 (4), 55 (17), 51 (3), 45 (8), 44 (3), 43 (42), 41 (7), 40 (3), 39 (6).

### Example 3

a) Preparation of (1,1-dimethyl-2-phenylethyl) hydrogen phthalate

8.0 g of potassium hydride (20% in oil, 39.9 mmol) were washed with pentane and THF. Then 10 ml of fresh THF were added and 5 g of 2-methyl-1-phenyl-2-propanol (33.3 mmol) in 10 ml of THF were added dropwise during 15 minutes. The resulting solution was stirred for 1 h at room temperature. Consequently, the reaction mixture was added dropwise over 15 minutes to a mechanically stirred solution of 4.93 g (33.3 mmol) of phthalic anhydride, 4.30 g (33.3 mmol) of DIEA and 0.40 g (3.3 mmol) of DMAP in 200 ml of THF. At the end of the introduction another 50 ml of THF were added and the reaction mixture was heated to 50° C. and left cooling to room temperature during 1 hour. The reaction mixture was poured into a stirred mixture of 300 ml of ice and 200 ml of aqueous KHSO₄ (5%). 200 ml of ether were added and the organic phase extracted twice with 100 ml of aqueous KHSO₄ (5%) and 3 times with brine. Extraction with 100 ml of a saturated aqueous solution of NaHCO₃ (2 times), treatment of the aqueous phase with 25 g of KHSO₄, re-extraction twice which 100 ml of ether, washing twice with 50 ml of aqueous KHSO₄ (5%), drying and concentration gave 7.42 g (yield=75%) of white crystals.

IR (neat, cm⁻¹): 2973 (w), 2919 (w), 2866 (w), 2661 (w), 2556 (w), 1716 (m), 1689 (s), 1596 (m), 1578 (m), 1490 (m), 1467 (w), 1452 (m), 1415 (m), 1383 (m), 1370 (m), 1310 (m), 1285 (s), 1268 (s), 1237 (m), 1207 (w), 1186 (w), 1140 (m), 1114 (s), 1068 (s), 1031 (w), 1009 (w), 968 (w), 938 (m), 910 (w), 866 (w), 844 (m), 833 (m), 806 (w), 792 (m), 772 (m), 737 (s), 724 (m), 699 (s), 684 (m), 670 (w).

¹H-NMR: 11.55 (br., 1 H); 7.91−7.85 (m, 1 H); 7.62−7.47 (m, 3 H); 7.29−7.15 (m, 5 H); 3.17 (s, 2 H); 1.58 (s, 6 H).

¹³C-NMR: 172.9 (s); 167.3 (s); 137.0 (s); 135.0 (s); 132.1 (d); 130.7 (d); 130.3 (d); 129.7 (d); 129.6 (s); 128.6 (d); 128.0 (d); 126.5 (d); 84.5 (s); 46.7 (t); 25.5 (q).

MS (EI): 167 (3), 150 (9), 149 (100), 147 (3), 146 (21), 133 (5), 132 (37), 122 (3), 121 (9), 118 (3), 117 (25), 115 (9), 105 (8), 104 (15), 93 (10), 92 (12), 91 (27), 77 (6), 76 (8), 73 (3), 70 (4), 65 (18), 61 (5), 59 (10), 57 (3), 55 (4), 51 (4), 50 (5), 45 (5), 44 (3), 43 (19), 41 (4), 39 (6).

b) Preparation of bis(1, 1-dimethyl-2-phenylethyl) 2,2′-(6-methyl-1,11-dioxo-2,6,10-triazaundecane-1,11-diyl)dibenzoate

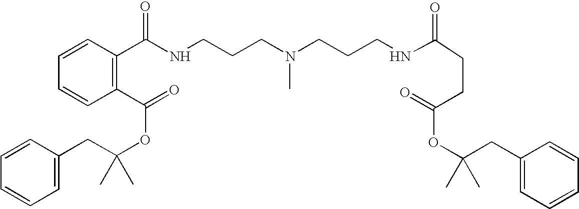

This compound was synthesized as described in Example 2b with 1.00 g (3.4 mmol) of (1,1-dimethyl-2-phenylethyl) hydrogen phthalate, 0.68 g (6.7 mmol) of triethylamine in 20 ml of CH₂Cl₂, 0.36 g (3.4 mmol) of ethyl chloroformate in 5 ml of CH₂Cl₂, 0.21 g (1.4 mmol) of 3,3′-methylamino-bis(propanamine) in 5 ml of CH₂Cl₂ and another 0.06 g (0.5 mmol) of ethyl chloroformate in 1 ml of CH₂Cl₂ followed by 0.12 g (1.3 mmol) of N,N-dimethylethylenediamine in 3 ml of CH₂Cl₂ to give 1.03 g (yield=97%) of a slightly yellow solid.

UV/Vis (water/acetonitrile 2:1): 274 (2200), 268 (sh, 2300), 264 (2400).

IR (neat, cm⁻¹): 3270 (m, br.), 3059 (w), 3027 (w), 2976 (w), 2924 (w), 2873 (w), 1708 (m), 1641 (m), 1596 (m), 1578 (m), 1537 (m), 1494 (w), 1481 (m), 1469 (m), 1452 (m), 1442 (m), 1383 (m), 1368 (m), 1290 (m), 1256 (m), 1215 (m), 1176 (m), 1182 (m), 1112 (m), 1084 (m), 1043 (m), 1030 (m), 970 (m), 889 (w), 847 (m), 829 (w), 788 (w), 773 (w), 730 (m), 701 (m).

¹H-NMR: 7.89 (t, J=5.7, 2 H); 7.52−7.44 (m, 4 H); 7.35−7.13 (m, 14 H); 3.45−3.29 (m, 4 H); 3.29−3.13 (m, 2 H); 3.10 (s, 4 H); 3.02−2.87 (m, 2 H); 2.52 (s, 3 H); 2.07−1.92 (m, 4 H); 1.48 (s, 12 H).

¹³C-NMR: 169.5 (s); 166.9 (s); 137.3 (s); 137.0 (s); 132.3 (s); 131.0 (d); 130.7 (d); 129.4 (d); 129.0 (d); 128.0 (d); 127.9 (d); 126.5 (d); 83.6 (s); 53.9 (t); 46.5 (t); 39.6 (q); 36.5 (t); 25.8 (q); 23.8 (t).

MS (EI): 150 (3), 148 (3), 135 (16), 132 (7), 117 (14), 115 (7), 104 (4), 93 (8), 92 (100), 91 (52), 89 (4), 77 (4), 76 (3), 65 (14), 63 (4), 59 (48), 58 (3), 57 (8), 51 (5), 50 (3), 44 (3), 43 (18), 41 (7), 39 (8).

### Example 4

Preparation of bis(1,1-dimethyl-2-phenylethyl) 2,2′-(1,11-dioxo-2,10-diazaundecane-1,11-diyl)dibenzoate

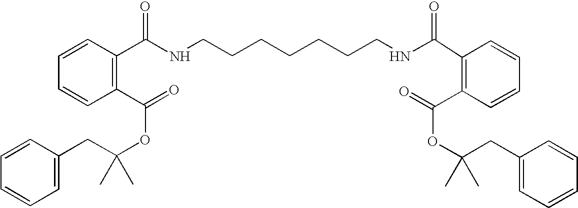

This compound was synthesized as described in Example 2b with 2.00 g (6.7 mmol) of (1,1-dimethyl-2-phenylethyl) hydrogen phthalate (prepared as described in Example 3a), 1.35 g (13.4 mmol) of triethylamine in 20 ml of CH₂Cl₂, 0.73 g (6.7 mmol) of ethyl chloroformate in 10 ml of CH₂Cl₂, 0.39 g (3.0 mmol) of 1,7-diaminoheptane in 10 ml of CH₂Cl₂ (added at room temperature) and another 0.11 g (1.0 mmol) of ethyl chloroformate in 5 ml of CH₂Cl₂ followed by 0.11 g (1.2 mmol) of N,N-dimethylethylenediamine in 5 ml of CH₂Cl₂. The mixture was kept stirring for 15 min, then poured into 50 ml of aqueous KHSO₄ (5%), stirred for 1 h and extracted with 30 ml of CH₂Cl₂. The organic phase was washed six times with 20 ml of aqueous KHSO₄ (5%), dried over Na₂SO₄, filtered, concentrated and dried under high vacuum. Plug filtration of the crude reaction product on 50 g of reversed phase RP C4 silica gel (Vydac®) with water/acetonitrile 1:1 then pure acetonitrile (both containing 0.1% of TFA) gave, after drying under high vacuum, 1.36 g (yield=29%) of a highly viscous yellow oil.

UV/Vis (water/acetonitrile 2:1): 273 (6800), 264 (sh, 7300), 258 (sh, 9000).

IR (neat, cm⁻¹): 3281 (m, br.), 3063 (w), 3027 (w), 2930 (m), 2854 (w), 2251 (w), 1777 (w), 1711 (s), 1640 (s), 1596 (w), 1576 (w), 1537 (s), 1493 (w), 1482 (w), 1467 (w), 1452 (m), 1443 (m), 1383 (m), 1368 (m), 1289 (s), 1256 (m), 1208 (s), 1158 (s), 1113 (s), 1081 (m), 1039 (w), 1030 (w), 974 (w), 917 (w), 890 (w), 846 (m), 801 (w), 772 (m), 729 (s), 701 (s).

¹H-NMR: 7.77−7.71 (m, 2 H); 7.52−7.35 (m, 6 H); 7.30−7.15 (m, 10 H); 6.06 (t, J=5.7, 2 H); 3.34 (q, J=6.6, 4 H); 3.19 (s, 4 H); 1.97 (s, 4 H); 1.54 (s, 12 H); 1.36 (s, 6 H).

¹³C-NMR: 170.1 (s); 166.0 (s); 137.5 (s); 137.1 (s); 131.5 (d); 130.8 (s); 130.6 (d); 129.96 (d); 129.6 (d); 128.0 (d); 127.8 (d); 126.5 (d); 84.1 (s); 46.1 (t); 40.1 (t); 29.2 (t); 28.8 (t); 26.7 (t); 25.9 (q).

MS (ESI): 693 (11), 692 (41), 691 ([M+H]⁺, 100), 560 (6), 559 (16), 428 (5), 427 (18).

### Example 5

a) Preparation of (±)-(1,5-dimethyl-1-vinyl-4-hexenyl) hydrogen phthalate

8.74 g of potassium hydride (20% in oil, 43.6 mmol) were washed with pentane and THF. Then 20 ml of THF were added and 6.17 g of linalol (40.0 mmol) in 10 ml of THF were added dropwise during 15 min. The reaction mixture was left stirring for 30 min at room temperature and then added dropwise during 15 minutes to a mechanically stirred solution of 5.40 g (36.4 mmol) of phthalic anhydride, 4.70 g (36.4 mmol) of DIEA and 0.44 g (3.6 mmol) of DMAP in 250 ml of THF and the reaction mixture was left stirring at room temperature for 18 hours. The reaction mixture was poured on 300 ml of ice and 400 ml of aqueous KHSO₄ (5%) were added and extracted with 300 ml of ether. The aqueous phase was re-extracted with 100 ml of ether. The combined organic phases were washed with 100 ml of aqueous KHSO₄ (5%), concentrated and taken up in 50 ml of ether. The solution was then treated with 20 ml of a solution of aqueous NaHCO₃ (5%) and washed twice with 20 ml of brine. Drying over Na₂SO₄ and concentrating gave 10.63 g (yield=91%) of a slightly orange oil.

IR (neat, cm⁻¹): 3070 (m), 2971 (m), 2910 (m), 2855 (m), 2649 (m), 2534 (m), 1692 (s), 1597 (m), 1580 (m), 1490 (m), 1450 (m), 1405 (m), 1375 (m), 1283 (s), 1259 (s), 1173 (w), 1126 (m), 1071 (s), 1038 (w), 1003 (w), 993 (w), 973 (w), 919 (m), 855 (w), 796 (m), 737 (m), 702 (w), 695 (w), 672 (m).

¹H-NMR: 8.87 (br., 1 H); 7.90−7.83 (m, 1 H); 7.74−7.68 (m, 1 H); 7.63−7.49 (m, 2 H); 6.13 (dd, J=17.4, 11.1, 1 H); 5.24 (d, J=17.4, 1 H); 5.19 (d, J=11.5, 1 H); 5.13−5.05 (m, 1 H); 2.10−1.79 (m, 4 H); 1.70 (s, 3 H); 1.63 (s, 3 H); 1.56 (s, 3 H).

¹³C-NMR: 172.5 (s); 166.5 (s); 141.2 (d); 134.1 (s); 131.9 (s,d); 130.6 (d); 130.3 (s); 129.7 (d); 129.0 (d); 123.7 (d); 113.7 (t); 85.2 (s); 40.1 (t); 25.6 (q); 23.0 (q); 22.41 (t); 17.6 (q).

MS (EI): 167 (9), 152 (9), 150 (9), 149 (91), 146 88), 137 (8), 136 (35), 123 (4), 122 (9), 121 (51), 111 (6), 109 (6), 108 (4), 107 (9), 105 (10), 96 (3), 95 (7), 94 (17), 93 (100), 92 (18), 91 (8), 83 (3), 82 (3), 81 (11), 80 (47), 79 (11), 77 (5), 71 (4), 69 (22), 68 (12), 67 (14), 65 (16), 59 (4), 55 (15), 53 (17), 51 (4), 45 (4), 43 (8), 41 (38), 39 (14).

b) Preparation of(±)-bis(1,5-dimethyl-1-vinyl-4-hexenyl) 2,2′-(6-methyl-1,11-dioxo-2,6,10-triazaundecane-1,11-diyl)dibenzoate

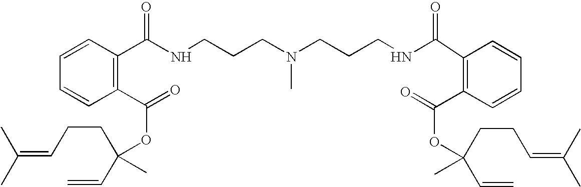

This compound was synthesized as described in Example 2b with 0.20 g (0.66 mmol) of (±)-(1,5-dimethyl-1-vinyl-4-hexenyl) hydrogen phthalate and 0.14 g (1.39 mmol) of triethylamine in 10 ml of CH₂Cl₂, 0.075 g (0.69 mmol) of ethyl chloroformate in 5 ml of CH₂Cl₂, 0.090 g (0.62 mmol) of 3,3′-methylamino-bis(propanamine) in 5 ml of CH₂Cl₂ and another 0.011 g (0.11 mmol) of ethyl chloroformate in 5 ml of CH₂Cl₂ followed by 0.050 g (0.55 mmol) of N,N-dimethylethylenediamine in 3 ml of CH₂Cl₂ 20 min later. The mixture was kept stirring for 10 min at 0° C., then poured into 20 ml of aqueous KHSO₄ (5%) and left stirring at room temperature for 1 hour. The organic phase was washed 10 times with 50 ml of aqueous KHSO₄ (5%), dried over Na₂SO₄, filtered, concentrated and dried under high vacuum to give 0.14 g (yield=32%) of the compound.

UV/Vis (water/acetonitrile 2:1): 283 (sh, 1900), 274 (2400).

hu 1H-NMR: 7.97−7.86 (t, J=5.5, 2 H); 7.70−7.61 (m, 2 H); 7.54−7.45 (m, 2 H); 7.43−7.31 (m, 4 H); 6.05 (dd, J=17.4, 11.1, 2 H); 5.14 (d, J=17.8, 2 H); 5.15−5.00(m, 2 H); 5.09 (d, J=11.1, 2 H); 3.50−3.33 (m, 4 H); 3.31−3.08 (m, 2 H); 3.07−2.84 (m, 2 H); 2.57 (s, 3 H); 2.14−1.95 (m, 8 H); 1.94−1.73 (m, 4 H); 1.66 (s, 6 H); 1.62 (s, 6 H); 1.56 (s, 6 H).

¹³C-NMR: 169.5 (s); 166.1 (s); 141.8 (d); 137.6 (s); 131.9 (s, 2x), 131.1 (d); 129.4 (d); 129.1 (d); 128.0 (d); 123.8 (d); 113.2 (t); 84.3 (s); 53.8 (t); 40.5 (t); 39.5 (q); 36.42 (t); 25.68 (q); 23.71 (t); 23.27 (q); 22.38 (t); 17.65 (q).

MS (ESI): 715 ([M+H]⁺, 12), 714 (M⁺, 12), 713 (90), 712 (100), 709 (3), 708 (3), 706 (5), 705 (3), 704 (4), 702 (3), 579 (4), 578 (20), 576 (3), 559 (3), 443 (3), 442 (3), 441 (20), 439 (3), 434 (3), 433 (3), 410 (5), 408 (7), 406 (54), 405 (27), 404 (3), 396 (3), 376 (8), 375 (18), 243 (4), 242 (6), 241 (11), 240 (40).

### Example 6

a) Preparation of 1,1-dimethyl-2-phenylethyl 2-(fluorocarbonyl)benzoate

A solution of 3.00 g (10.1 mmol) of (1,1-dimethyl-2-phenylethyl) hydrogen phthalate (prepared as described in Example 3a) and 0.80 g (10.1 mmol) of pyridine in 25 ml of CH₂Cl₂ was cooled down to −20° C. before 1.60 g (12.1 mmol) of cyanuric fluoride in 5 ml of CH₂Cl₂ were added dropwise during 10 min. The reaction mixture was left stirring at −20° C. for 30 min and 1 h at room temperature, filtered and rinsed with 20 ml of dichloromethane. The filtrate was washed with 60 ml of water. The aqueous phase was extracted twice with 20 ml of CH₂Cl₂. The organic phases were dried over Na₂SO₄ and concentrated. Column chromatography (SiO₂, heptane/ether 4:1) and drying (0.2 mbar, 30 min) gave 2.37 g (yield=78%) of a slightly yellow oil.

IR (neat, cm⁻¹): 3061 (w), 3028 (w), 2978 (w), 2928 (w), 1816 (s), 1712 (s), 1598 (m), 1578 (m), 1493 (m), 1468 (w), 1452 (m), 1385 (m), 1369 (m), 1289 (s), 1269 (s), 1215 (s), 1232 (s), 1177 (m), 1138 (m), 1108 (s), 1090 (s), 1043 (m), 1029 (w), 1005 (s), 914 (w), 890 (w), 863 (w), 845 (m), 826 (w), 777 (m), 759 (m), 772 (s), 699 (s), 673(m). ¹H-NMR: 7.80−7.75 (m, 1 H); 7.75−7.69 (m, 1 H); 7.67−7.54 (m, 2 H); 7.31−7.17 (m, 5 H); 3.21 (s, 2 H); 1.60 (s, 6 H).

¹³C-NMR: 165.6 (s); 159.5 (s); 136.8 (s); 134.6 (s); 133.1 (d); 131.1 (d); 130.6 (d); 130.1 (d); 129.4 (d); 128.1 (d); 126.6 (s); 125.9 (s); 85.3 (s); 46.4 (t); 25.6 (q).

MS (CI): 319 (13), 318 ([M+NH₄]⁺, 68), 185 (3), 184 (10), 183 (100), 169 (3), 168 (31), 167 (6), 166 (54), 93 (5).

b) Preparation of Dendrimer 4-cascade: 1,4-diaminobutane[4-N,N,N′,N′]:N-(2-[(1,1-dimethyl-2-phenylethoxy)carbonyl]benzoyl)propylamine

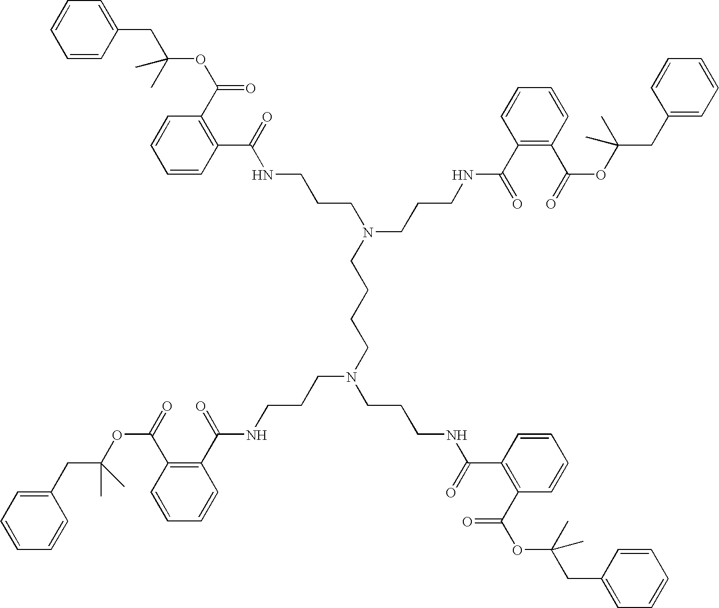

A solution of 0.077 g (0.24 mmol) of dendrimer 4-cascade: 1,4-diaminobutane[4-N,N,N′,N′]:propylamine (Astramol®-Am-4, origin: DSM) in 2 ml of dichloromethane was added dropwise during 5 min to a stirred solution of 0.35 g (1.17 mmol) of freshly prepared 1,1-dimethyl-2-phenylethyl 2-(fluorocarbonyl)benzoate and 0.235 g (2.33 mmol) of triethylamine in 6 ml of dichloromethane at 0° C. After stirring at 0° C. for 2 h, the reaction mixture was left warming up to room temperature and extracted with 10 ml of aqueous KHSO₄ (5%). The aqueous phase was re-extracted twice with 5 ml of CH₂Cl₂ and the organic phases dried over Na₂SO₄. Column chromatography (RP-C4 (Vydac® 214TP C4), water/acetonitrile 1:1 containing 0.1% of TFA) and drying under high vacuum gave 0.163 g (yield=47%) of the target compound.

IR (neat, cm⁻¹): 3306 (w, br.), 3061 (w), 3027 (w), 2979 (w), 2936 (w), 2872 (w), 1772 (m), 1706 (s), 1658 (m), 1596 (m), 1579 (w), 1542 (m), 1468 (w), 1452 (m), 1440 (m), 1397 (w), 1385 (m), 1368 (m), 1301 (m), 1288 (m), 1257 (w), 1201 (s), 1140 (s), 1116 (s), 1085 (s), 1042 (w), 1030 (w), 972 (w), 907 (s), 845 (m), 797 (m), 776 (m), 721 (s), 700 (s).

¹H-NMR: 7.70−7.62 (m, 4H); 7.47−7.33 (m, 8H); 7.33−7.08 (m, 28H); 3.52−3.20 (m, 16H); 3.19−2.98 (m, 4H); 3.08 (s, 8H); 2.08−1.89 (m, 8H); 1.89−1.70 (m, 4H); 1.47 (s, 24H).

¹³C-NMR: 172.4 (s); 165.9 (s); 136.8 (s); 136.4 (s); 131.9 (d); 130.6 (d); 130.5 (s); 130.0 (d, 2x); 128.1 (d); 127.5 (d); 126.7 (d); 84.2 (s); 51.4 (t); 50.7 (t); 46.5 (t); 36.7 (t); 25.3 (q); 23.8 (t); 20.5 (t).

MS (ESI): 1437.7 ([M+H]⁺).

### Example 7

Preparation of Dendrimer 8-cascade: ], 4-diaminobutane[4-N,N,N′,N′]:1-azabutylidene:N-(2-[(1,1-dimethyl-2-phenylethoxy)carbonyl]benzoyl)propylamine

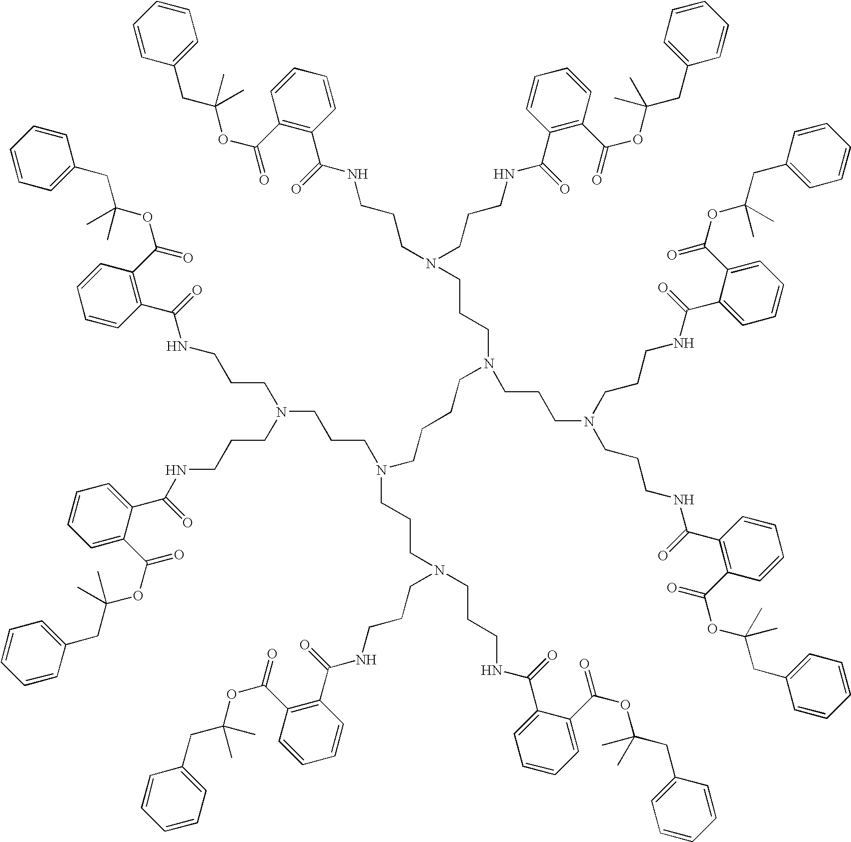

A solution of 0.36 g (0.47 mmol) of dendrimer 8-cascade: 1,4-diaminobutane[4-N,N,N′,N′]:1-azabutylidene:propylamine (Astramol®-Am-8, origin: DSM) in 10 ml of dichloromethane was added dropwise during 10 min to a stirred solution of 1.34 g (4.46 mmol) of freshly prepared 1,1-dimethyl-2-phenylethyl 2-(fluorocarbonyl)benzoate (see Example 6a) and 0.90 g (8.92 mmol) of triethylamine in 20 ml of dichloromethane at room temperature. After stirring at room temperature for 30 min, the reaction mixture was poured into 50 ml of aqueous KHSO₄ (5%) and ice and extracted with 20 ml of CH₂Cl₂The aqueous phase was re-extracted with 20 ml of CH₂Cl₂ and the organic phases dried over Na₂SO₄. Column chromatography (RP-C4 (Vydac® 214TP C4), water/acetonitrile 1:1, then pure acetonitrile, both containing 0.1% of TFA) and drying under high vacuum gave 0.40 g (yield=28%) of the target compound.

IR (neat, cm⁻1): 3274 (w, br.), 3062 (w), 3026 (w), 2977 (w), 2932 (w), 2871 (w), 1775 (m), 1706 (m), 1649 (m), 1596 (m), 1578(w), 1536 (m), 1470 (w), 1453 (m), 1443 (m), 1384 (m), 1369 (m), 1300 (m), 1289 (m), 1258 (w), 1198 (s), 1161 (s), 1136 (s), 1114 (s), 1085 (s), 1044(m), 1030 (w), 974 (w), 890 (w), 845 (m), 796 (m), 779 (w), 773 (w), 730 (m), 720 (m), 701 (s), 663 (w).

¹H-NMR: 7.66−7.56 (m, 8H); 7.51−7.08 (m, 72H); 3.52−3.29 (m, 32H); 3.29−3.10 (m, 20H); 3.05 (s, 16H); 2.47−2.21 (m, 8H); 2.18-1.94 (m, 16H); 1.87−1.69 (m, 4H); 1.44 (s, 48H).

¹³C-NMR: 172.6 (s); 165.8 (s); 136.76 (s); 135.9 (s); 131.8 (d); 130.68 (s); 130.6 (d); 130.1 (d); 130.0 (d); 128.1 (d); 127.6 (d); 126.65 (d); 84.2 (s); 52.2 (t); 51 (t); 50.2 (t); 49.6 (t); 46.5 (t); 37.0 (t); 25.6 (q); 23.5 (t); 20.4 (t); 18.8 (t).

MS (ESI): 3014.6 ([M+H]⁺), 1508.4 ([M+2H]²⁺), 1005.6 ([M+3H]³⁺).

### Example 8

Preparation of dendrimer 16-cascade: 1,4-diaminobutane[4-N,N,N′,N′:(1-azabutylidene)²:N-(2-[(1,1-dimethyl-2-phenylethoxy)carbonyl]benzoyl)propylamine

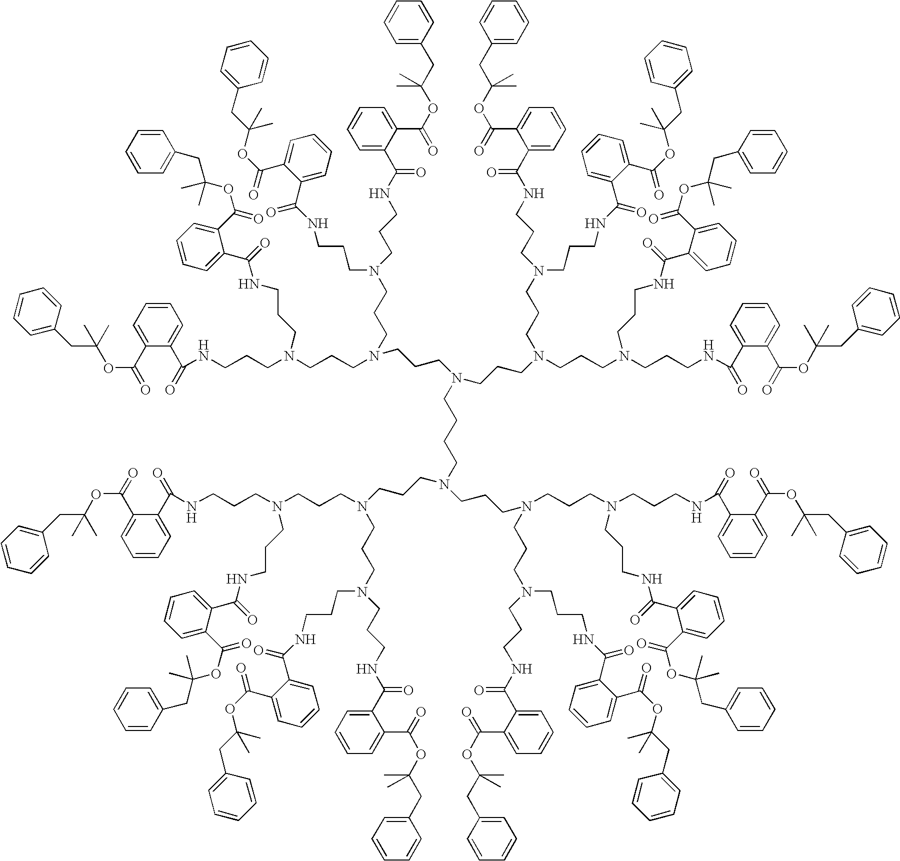

This compound was synthesized as described in Example 7 with 0.33 g (0.20 mmol) of dendrimer 16-cascade: 1,4-diaminobutane[4-N,N,N′,N′]:(1-azabutylidene)²:propylamine (Astramol®-Am-16, origin: DSM) in 10 ml of dichloromethane, 1.05 g (3.50 mmol) of freshly prepared 1,1-dimethyl-2-phenylethyl 2-(fluorocarbonyl)benzoate (see Example 6a) and 0.71 g (6.99 mmol) of triethylamine in 20 ml of dichloromethane. The reaction mixture was poured into 30 ml of aqueous KHSO₄ (5%), extracted and dried over Na₂SO₄. MPLC (RP-C4 (Vydac® 214TP C4), water/acetonitrile 1:1 then 1:4, containing 0.1% of TFA) with addition of 0.015 g of KHSO₄ to the product fraction gave, after concentration and lyophilisation, 0.19 g (yield Ca. 15%) of a white solid.

IR (neat, cm⁻¹): 3294 (m, br.), 3601 (w), 2952 (m, br.), 2869 (w), 2647 (w, br.), 1777 (m), 1707 (s), 1665 (s), 1649 (s), 1596 (m), 1578 (m), 1540 (m), 1469 (m), 1453 (m), 1384 (m), 1369 (m), 1292(s), 1259 (w), 1199(s), 1173 (s), 1139(s), 1118 (s), 1086(s), 1044 (m), 980 (m), 920 (w), 889 (w), 847 (m), 798 (m), 817 (w), 778 (w), 772 (w), 761 (w), 730 (m), 720 (m), 702 (s), 676 (w).

¹H-NMR (400 MHz): 7.9−6.7 (m, 160 H); 4.0−2.6 (m, br., 116 H); 3.05 (s, br., 32 H); 2.6−1.0 (m, br., 60 H); 1.44 (s, br., 96 H).

¹³C-NMR (100.6 MHz): 171.4 (s); 166.2 (s); 136.9 (s); 136.7 (s); 131.6 (d); 131.1 (s); 130.6 (d); 129.8 (d); 129.7 (d); 128.1 (d); 127.6 (d); 126.6 (d); 84.1 (s); 50.9 (t, br.); 49.9 (t, br.); 49.0 (t, br.); 46.5 (t); 36.8 (t); 25.7 (q); 23.7 (t); 18.5 (t, br.).

MS (ESI): 2058.0 ([M+3H]³⁺), 1543.8 ([M+4H]⁴⁺), 1235.3 ([M+5H]⁵⁺).

### Example 9

a) Preparation of (E)-3,7-dimethyl-2,6-octadienyl hydrogen phthalate

A solution of 10.0 g (64.9 mmol) of geraniol, 9.6 g (64.9 mmol) of phthalic anhydride, 8.4 g (64.9 mmol) of DIEA and 0.8 g (6.5 mmol) of DMAP in 130 ml of dichloromethane was stirred at room temperature for 5 h. The reaction mixture was extracted with aqueous KHSO₄ (5%), washed with water, dried over Na₂SO₄ and concentrated to give 17.5 g (89%) of monophthalate as a pale yellow oil.

IR (neat, cm ⁻¹): 2965 (m), 2914 (m), 2854 (m), 2663 (w), 2541 (w), 1724 (s), 1696 (s), 1599 (m), 1578 (m), 1491 (m), 1447 (m), 1410 (m), 1376 (m), 1339 (w), 1281 (s), 1256 (s), 1164 (w), 1120 (s), 1069 (s), 1037 (m), 978 (w), 959 (w), 924 (m), 888 (w), 831 (w), 797 (m), 790 (m), 772 (m), 740 (s), 703 (m), 685 (m).

¹H-NMR: 7.95−7.90 (m, 1 H); 7.72−7.67 (m, 1 H); 7.63−7.52 (m, 2 H); 5.49−5.42 (m, 1 H); 5.09−5.02 (m, 1 H); 4.86 (d, J=7.1, 2 H); 2.20−2.00 (m, 4 H); 1.75 (s, 3 H 1.65 (s, 3 H); 1.57 (s, 3 H).

¹³C-NMR: 172.3 (s); 168.3 (s); 143.2 (s); 133.8 (s); 132.21(d); 131.8 (s); 130.7 (d); 129.91 (d); 129.9 (s); 128.7 (d); 123.8 (d); 117.6 (d); 62.8 (t); 39.6 (t); 26.3 (t); 25.7 (q); 17.7 (q); 16.5 (q).

MS (CI): 320 ([M+NH₄]⁺, 2), 185 (16), 184 (100), 167 (14), 154 (10), 138 (6), 137 (49), 81 (3).

b) Preparation of 2-[(E)-3,7-dimethyl-2,6-octadienyloxycarbonyl]benzoyl ethyl carbonate

Ethyl chloroformate (3.59 g, 1 equiv.) was added dropwise at 0° C. to a solution of 10 g (33 mmol) of (E)-3,7-dimethyl-2,6-octadienyl hydrogen phthalate and 4.5 ml (1 equiv.) of triethylamine in 60 ml of dichloromethane. The reaction mixture was stirred for 3 h at room temperature, then washed with aqueous KHSO₄ (5%) and water, dried over Na₂SO₄ and the solvent was evaporated. The crude mixed carbonic anhydride (11.23 g, 91% crude yield) was kept in the freezer under argon atmosphere and used as such for the grafting of polymers.

c) Preparation of a (E)-N-[2-(3,7-dimethyl-2,6-octadienyloxycarbonyl)benzoyl]substituted aminomethylated polystyrene

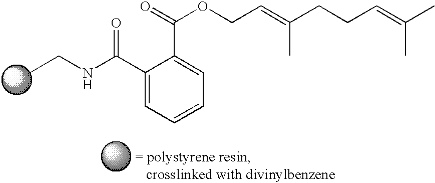

A mixture of 0.5 g (1.33 mmol) of 2-[(E)-3,7-dimethyl-2,6-octadienyloxycarbonyl]benzoyl ethyl carbonate, 0.967 g of aminomethylated polystyrene resin crosslinked with divinylbenzene (AM resin VHL, origin: Novabiochem, Switzerland) with 1.38 mmol/g of NH₂ groups (1.0 equiv.) and 0.45 ml of DIEA (1 equiv.) in 10 ml of dichloromethane were mechanically stirred. After 1 h, a second equivalent of mixed anhydride in 10 ml of dichloromethane was added and the reaction was stirred for another 2.5 h. The liquid phase was then removed by succion and the resin beads alternatively rinsed with dichloromethane and methanol. The resin was transferred in a flask and dried under vacuum to yield 1.29 g. The Gisin test indicated the presence of 0.015 mmol/g of unreacted NH₂ groups corresponding to a grafting yield of 98.5% (taking the weight increase of the resin into account).

IR (neat, cm⁻¹): 3308 (w), 3058 (w), 3023 (m), 2918 (m), 2846 (w), 1718 (m), 1654 (m), 1600 (m), 1540−10 (m), 1491 (m), 1450 (m), 1374 (w), 1364 (w), 1283 (m), 1257 (m), 1152 (w), 1124 (m), 1073 (m)1065 (w), 1027 (w), 904 (w), 820 (w), 754 (m), 685 (s).

### Example 10

a) Preparation of a glycyl substituted aminomethylated polystyrene

A mixture of 0.484 g (2.76 mmol) of N-tert-butyloxycarbonyl-glycine, 1.44 g (2 equiv.) of (benzotriazol-1-yloxy)tripyrrolidinophosphonium hexafluorophosphate (PyBOP®, origin: Novabiochem, Switzerland), 1 g of aminomethylated polystyrene resin crosslinked with divinylbenzene (AM resin VHL, origin: Novabiochem, Switzerland) with 1.38 mmol/g of NH₂ groups (1.0 equiv.), 0.5 ml (1 equiv.) of DIEA in 30 ml of dichloromethane was mechanically stirred. After 1.5 h, the reaction mixture was removed, the resin washed and reacted with 50 ml of a mixture of TFA/dichloromethane 1:1 for 1 h, then with 50 ml of pure TFA for 2 h.

b) Preparation of a (E)-2-{[2-(3,7-dimethyl-2,6-octadienyl-oxycarbonyl)benzoyl]amino}ethanoyl substituted aminomethylated polystyrene

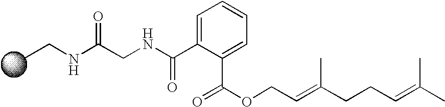

This compound was synthesized as described in Example 9c with 0.5 g of the resin obtained above and 0.5 g (2 equiv.) of 2-[(E)-3,7-dimethyl-2,6-octadienyloxycarbonyl]benzoyl ethyl carbonate (see Example 9b) to give 0.55 g of the modified polymer. The Gisin test indicated the presence of 0.0028 mmol/g of unreacted NH₂ groups, corresponding to a grafting yield of 99.7%.

IR (neat, cm⁻¹): 3357 (w), 3058 (w), 3023 (m), 2918 (m), 2846 (w), 1719 (m), 1657 (m), 1600 (m), 1540-1512 (m), 1491 (m), 1450 (m), 1364 (w), 1263 (m), 1152 (w), 1111 (w), 1070 (w), 1065 (w), 1027 (w), 950 (w), 904 (w), 820 (w), 754 (m), 685 (s).

### Example 11

a) Preparation of (E)-12-[(12-{[2-(3,7-dimethyl-2,6-octadienyloxycarbonyl) benzoyl]amino}dodecanoyl)amino]dodecanoic acid (A) and (E)-12-([2-(3,7-dimethyl-2,6-octadienyloxycarbonyl)benzoyl]amino}dodecanoic acid (B)

A solution of 1.8 g (16.5 mmol) of ethyl chloroformate in 60 ml of dichloromethane was added dropwise (during 15 min) to a stirred solution of 5.0 g (16.5 mmol) of (E)-3,7-dimethyl-2,6-octadienyl hydrogen phthalate and 3.3 g (33.0 mmol) of triethylamine in 100 ml of dichloromethane at 0° C. After warming up to room temperature, 3.6 g (16.5 mmol) of 12-aminododecanoic acid were added in small portions, and the reaction mixture left stirring for 18 h. Filtration, washing twice with aqueous KHSO₄ (5%), drying over Na₂SO₄ and concentration afforded 7.3 g of the crude product. Recrystallizing from 20 ml of acetonitrile afforded 2.84 g (yield=25%) of A as a white solid.

IR (neat, cm⁻¹): 3370 (w), 3287 (m), 3054 (w), 2918 (s), 2847 (s), 1740 (m), 1725 (s), 1660 (m), 1635 (s), 1595 (m), 1573 (m), 1537 (s), 1466 (s), 1454 (w), 1412 (m), 1383 (m), 1330 (m), 1310 (m), 1280 (s), 1261 (s), 1240 (m), 1215 (m), 1189 (w), 1176 (m), 1160 (w), 1126 (s), 1085 (m), 1059 (m), 1044 (w), 986 (w), 965 (w), 935 (m), 900 (w), 869 (w), 836 (w), 823 (w), 797 (m), 784 (w), 771 (m), 738 (m), 722 (m), 705 (m), 690 (m).

¹H-NMR: 7.89−7.83 (m, 1 H); 7.55−7.40 (m, 3 H); 6.15 (t, J=5.5, 1 H); 5.89 (t, J=5.7, 1 H); 5.47−5.38 (m, 1 H); 5.13−5.05 (m, 1 H); 4.80 (d, J=7.1, 2 H); 3.41 (q, J=6.6, 2 H); 3.19 (q, J=6.6, 2 H); 2.31 (t, J=7.3, 2 H); 2.19−2.01 (m, 6 H); 1.74 (s, 3 H); 1.68 (s, 3 H); 1.66−1.53 (m, 3 H); 1.60 (s, 3 H); 1.52−1.41 (m, 3 H); 1.40−1.17 (m, 30 H).

¹³C-NMR: 178.0 (s); 173.6 (s); 169.5 (s); 166.8 (s); 142.5 (s); 138.3 (s); 131.8 (s); 131.8 (d); 130.0 (d); 129.4 (s); 127.7 (d); 123.7 (d); 118.0 (d); 62.5 (t); 40.2 (t); 39.6 (t); 39.5 (t); 36.8 (t); 34.1 (t); 29.6 (t); 29.5 (t, 2x); 29.4 (t, 3x); 29.3 (t, 2x); 29.3 (t, 3x); 29.2 (t); 29.0 (t); 27.0 (t); 26.9 (t); 26.3 (t); 25.8 (t); 25.7 (q); 24.8 (t); 17.7 (q); 16.6 (q).

MS (ESI): 699 (13), 698 (47), 697 ([M+H]⁺, 100), 562 (12), 561 (30), 543 (5), 137 (5).

Concentration of the mother liquor gave 3.46 g of a yellow oil. MPLC of 2 g (RP-C4 (Vydac® 214TP C4), water/acetonitrile 1:1 containing 0.1% of TFA) gave 0.87 g (yield=18%) of B.

IR (neat, cm¹): 3290 (w, br.), 2920 (s), 2851 (s), 1709 (s), 1632 (s), 1597 (m), 1578 (m), 1543 (s), 1484 (w), 1444 (s), 1375 (m), 1284 (s), 1255 (s), 1204 (m), 1161 (s), 1125 (s), 1075 (s), 1040 (m), 932 (s), 882 (w), 827 (w), 775 (m), 742 (m), 721 (m), 705 (m), 670 (w).

¹H-NMR: 8.62 (s, br., 1 H); 7.89−7.83 (m, 1 H); 7.54−7.39 (m, 3 H); 6.10 (t, J=5.5, 1 H); 5.47−5.38 (m, 1 H); 5.13−5.05 (m, 1 H); 4.80 (d, J=7.1, 2 H); 3.41 (q, J=6.7, 2H); 2.31 (t, J=7.5, 2 H); 2.17−2.01 (m, 4 H); 1.74 (s, 3 H); 1.68 (s, 3 H); 1.68−1.53 (m, 4 H); 1.60 (s, 3 H); 1.42−1.18 (m, 14 H).

¹³C-NMR: 179.2 (s); 169.7 (s); 166.8 (s); 142.6 (s); 138.1 (s); 131.8(s, d); 130.06 (d); 129.5 (d); 129.4 (s); 127.7 (d); 123.7 (d); 118.0 (d); 62.5 (t); 40.3 (t); 39.6 (t); 34.08 (t); 29.5 (t); 29.5 (t); 29.4 (t, 2x); 29.3 (t); 29.2 (t); 29.0 (t); 27.0 (t); 26.32 (t); 25.7 (q); 24.7 (t); 17.7 (q); 16.6 (q).

MS (ESI): 500 ([M+H]⁺, 5), 366 (4), 365 (26), 364 (100), 346 (8).

b) Preparation of (E)-12-([2-(3,7-dimethyl-2,6-octadienyloxycarbonyl)benzoyl]amino}dodecanoyl ethyl carbonate

Ethyl chloroformate (0.136 ml, 1 equiv.) was added dropwise at 0° C. to a solution of 0.71 g (1.4 mmol) of (E)-12-{[2-(3,7-dimethyl-2,6-octadienyl-oxycarbonyl) benzoyl]amino}dodecanoic acid and 0.2 ml (1 equiv.) of triethylamine in 20 ml of dichloromethane. The reaction mixture was stirred for 2 h at room temperature and used as such for the polymer grafting.

c) Preparation of a (E)-12-([2-(3,7-dimethyl-2,6-octadienyloxycarbonyl)benzoyl]amino}dodecanoyl substituted aminomethylated polystyrene

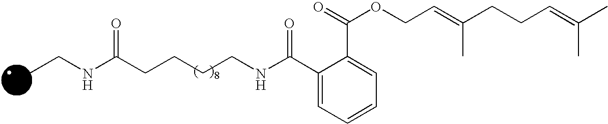

This compound was synthesized as described in Example 9c with 0.5 g of aminomethylated polystyrene resin crosslinked with divinylbenzene (AM resin VHL, origin: Novabiochem, Switzerland) with 1.38 mmol/g of NH₂ groups (1.0 equiv.) and the solution of (E)-12-{[2-(3,7-dimethyl-2,6-octadienyl-oxycarbonyl)benzoyl]amino}dodecanoyl ethyl carbonate described above to give 0.77 g of the modified polymer. The Gisin test indicated the presence of 0.0255 mmol/g of unreacted NH₂ groups, corresponding to a grafting yield of 97.0%.

IR (neat, cm⁻¹): 3292(w), 3058 (w), 3023 (m), 2918 (m), 2846 (w), 1714(s), 1643(s), 1600 (m), 1535(s), 1491 (m), 1450 (m), 1364 (w), 1256(m), 1152 (w), 1124(m), 1065 (w), 1027 (w), 904 (w), 820 (w), 754 (m), 685 (s).

### Example 12

Preparation of a (E)-N-[2-(3,7-dimethyl-2,6-octadienyloxycarbonyl)benzoyl]and N′-[(2-methoxyethoxy)-poly-(2-ethoxy)]carbonyl substituted aminomethylated polystyrene

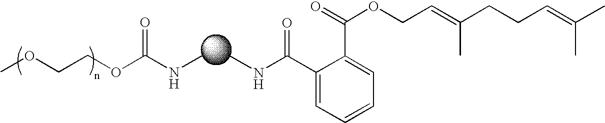

This compound was synthesized as described in Example 9c with 0.464 g of aminomethylated polystyrene resin crosslinked with divinylbenzene (AM NovaGel HL, origin: Novabiochem, Switzerland) with 0.72 mmol/g of NH₂ groups (1.0 equiv.) and 0.5 g (4 equiv.) of 2-[(E)-3,7-dimethyl-2,6-octadienyloxycarbonyl]benzoyl ethyl carbonate (see Example 9b) to give 0.34 g of the modified polymer. The Gisin test indicated the presence of 0.013 mmol/g of unreacted NH₂ groups, corresponding to a grafting yield of 97.8%.

IR (neat, cm⁻¹): 3322 (w), 3023 (w), 2876 (m), 1719 (m), 1663 (m), 1600 (w), 1536−1512 (m), 1512 (w), 1492 (w), 1466 (m), 1452 (m), 1342 (m), 1279 (m), 1240 (m), 1144 (m), 1100 (s), 1060 (m), 962 (m), 841 (m), 758 (m), 698 (m).

### Example 13

Preparation of a 2-((E)-[2-(3,7-dimethyl-2,6-octadienyl-oxycarbonyl)benzoyl]amino}[ethoxy-2-poly-(2-ethoxy)]methyl substituted polystyrene

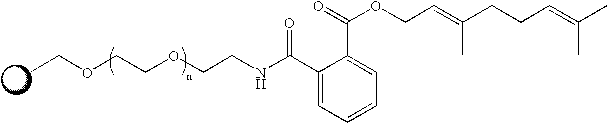

This compound was synthesized as described in Example 9c with 0.495 g of aminomethylated polystyrene resin crosslinked with divinylbenzene (AM NovaSyn TG, origin: Novabiochem, Switzerland) with 0.27 mmol/g of NH₂ groups (1.0 equiv.) and 0.2 g (4 equiv.) of 2-[(E)-3,7-dimethyl-2,6-octadienyloxycarbonyl]benzoyl ethyl carbonate (see Example 9b) to give 0.37 g of the modified polymer. The Gisin test indicated the presence of 0.013 mmol/g of unreacted NH₂ groups, corresponding to a grafting yield of 97.8%.

IR (neat, cm⁻¹): 3024 (w), 2860 (m), 1714(w), 1665(w), 1600 (w), 1537 (w), 1492 (w), 1466 (m), 1452 (m), 1358 (w), 1341 (m), 1278 (m), 1240 (m), 1144 (m), 1100 (s), 1060 (m), 960 (m), 841 (m), 758 (m), 698 (m).

### Example 14

Measurement of the Fragrance Release by HPLC

Buffer solutions were prepared by dissolving two phosphate or borate buffer tablets (origin: Fluka, Switzerland) in a mixture of 160 ml water and 40 ml acetonitrile, respectively. To determine the exact pH value of the reaction solution, 10 ml of the buffer solutions were diluted with 2 ml of acetonitrile and the pH values measured (on a Mettler Toledo MP220 apparatus with an InLab 410 Ag/AgCl glass electrode) to be 7.62 (phosphate buffer) and 10.47 (borate buffer).

a) Amount of Cyclization of the Precursor Under Alkaline Hydrolysis Conditions

0.2 ml of a solution of 35 to 45 mg of the precursors in 25 ml of acetonitrile were added to 1.0 ml of a buffer solution at 20° C. The mixture was immediately injected in a HPLC apparatus (t=0), eluted at 1 ml/min on a reversed phase column with a mixture of water/acetonitrile containing 0.1% of TFA. Then the decrease of the amount of precursor and the simultaneous formation of the cyclized products was monitored at different time intervals at λ=254 and 280 nm. Chromatograms were recorded on a Macherey-Nagel, Nucleosil® 100-5 C18 column (250×4 mm i.d.) using a water/acetonitrile gradient (70:30 to 20:80 during 20 min) or on a Merck Chromolith™ SpeedROD RP-C18e column (50×4.6 mm i.d.) using a water/acetonitrile gradient (70:30 to 40:60 during 3 min). The results are summarized in the following table:

| Compound | | | Amount of cyclized |
|---|---|---|---|
| Example N° | pH | Time [h] | precursor* |
| 1 | 7.62 | 4.7 | 97% |
| 2b | 7.62 | 2.1 | 98% |
| 3b | 7.62 | 22.4 | 69% |
| 4 | 10.47 | 3.0 | 98% |
| 5b | 7.62 | 9.4 | 72% |
| 6b | 7.62 | 24.6 | 80% |

*determined for the first step of cyclization only, % relative to the total amount of the starting compound

All compounds tested released the desired perfumery alcohol. The rate of release can be influenced by the choice of the pH, by the type of alcohol to be released as well as by the nature of the substrate linked to the carbamoyl moiety.

b) Amount of Perfumery Alcohols Released by Alkaline Hydrolysis

About 25 mg of the precursors were placed in 1 ml of a buffer solution, 0.2 ml of acetonitrile was added and the supernatant solution was immediately injected in a 20 HPLC apparatus (t=0), eluted at 3 ml/min on a reversed phase column with a mixture of water/acetonitrile containing 0.1% of TFA. The amount of the released alcohol was monitored by HPLC analysis at different time intervals at λ=214 or 254 nm. An external calibration curve for the corresponding alcohol in acetonitrile has been obtained from 4-8 dilutions. Chromatograms were recorded on a Merck Chromolith™ Performance RP-C18e column (100×4.6 mm i.d.) using a water/acetonitrile gradient (100:0 for 0.2 min then to 0:100 during 10 min or 80:20 to 20:80 during 10 min). The results are summarized in the following table:

| Compound of | | | Amount of released |
|---|---|---|---|
| Example N° | pH | Time [d] | alcohol* |
| 7 | 10.47 | 2 | 29% |
| 8 | 10.98**) | 4 | 69% |
| 9c | 10.47 | 3 | 3% |
| 10b | 10.47 | 3 | 42% |
| 11c | 10.47 | 5 | 30% |
| 12 | 10.47 | 3 | 74% |
| 13 | 10.47 | 3 | 74% |

*% relative to the total amount of the starting compound
**phosphate-bicarbonate buffer in water/acetonitrile 16:9.

It was verified that the polymer beads (compounds of Examples 9-13) did not contain free geraniol by washing the polymer (10 mg) with pure acetonitrile (0.5 ml). As for dimeric 2-carbamoyl precursors (see under a), it is possible to tune kinetic release through the nature of the substrate connected to the carbamoyl moiety from a slow release in a hydrophobic environment to a fast release in a more hydrophilic environment. The good accessibility of water molecules close to the precursor moiety is thus a very important factor for the speed of fragrance release. This could be achieved either by the presence of an hydrophilic spacer between the precursor and the polymer or by an hydrophilic arm near the precursor moiety.

### Example 15

Measure of Fragrance Release by UV Spectroscopy

2 ml of a precursor solution (35-55 mg in 25 ml of acetonitrile, at 20° C.) were added, at t=0, to 10 ml of a phosphate buffer solution (prepared as described in Example 14).

Hydrolysis was followed by recording the absorption spectra of the reaction mixture at constant time intervals in the range of 260-360 nm with a scanning rate of 960 nm/min until completion of the hydrolysis.

Kinetic measurement by UV spectroscopy for (±)-bis(1-benzylbutyl) 2,2′-(6-methyl-1,11-dioxo-2,6,10-triazaundecane-1,11-diyl)dibenzoate (Example 2b)

[image]

Using the same method the hydrolysis of the following compounds was also verified for bis(1,1-dimethyl-2-phenylethyl) 2,2′-(6-methyl-1,11-dioxo-2,6,10-triazaundecane-1,11-diyl)dibenzoate (Example 3b), bis(1,5-dimethyl-1-vinyl-4-hexenyl) 2,2°-(6-methyl-1,11-dioxo-2,6,10-triazaundecane-1,11-diyl)dibenzoate (Example 5b) and dendrimer 4-cascade: 1,4-diaminobutane[4-N,N,N′,N′]:N-(2-[(1,1-dimethyl-2-phenylethoxy)carbonyl]benzoyl)propylamine (Example 6b).

### Example 16

Release Properties of Grafted Polymers Under Ambient Conditions

The polymers prepared in Examples 12 and 13 are able to release geraniol upon simple exposure to ambient humidity of the air at room temperature. Thus, after 100 days they released 8% and 33% of geraniol, respectively, as measured by HPLC as described in Example 14b.

What is claimed is:

1. A compound of formula 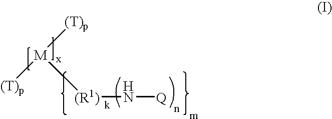
wherein
a) k represents 1 or 0;
b) n represents an integer from 0 to 4;
c) x represents an integer from 1 to 50000;
d) p represents 1 or 0 if x≧2, or 1 if x=1;
e) m represents 1 or 2 if x>1, an integer from 2 to 4 if x=1, or an integer from 2 to 80 if M represents a dendritic core;
f) R¹ represents a hydrogen atom (in the case where n=0), a multivalent radical (with a n+1 valence) derived from a polypropylene- or polyethylene-glycol having an average molecular weight of 50 g/mol and 4500 g/mol, or a multivalent radical (with a n+1 valence) derived from a C₁-C₂₂ linear or branched alkyl, alkenyl or alkylbenzene radical, possibly substituted, and the radical may contain in the main chain from 1 to 10 functional groups selected from the group consisting of carbonate ether, ester, ketone, amine, quaternary amines and amides; and with the proviso that at least two R¹ in formula (I) are not a hydrogen atom;
g) Q represents a hydrogen atom or a radical of the formulae 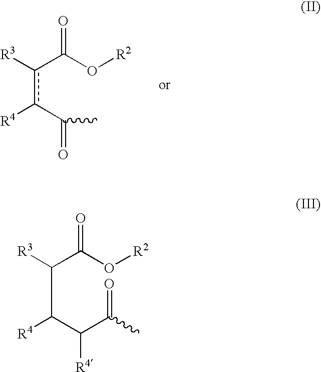
in which the wavy line indicates the location of the bond between the Q moiety and the NH group, the dotted line indicates the location of a single or double bond;
R² represents a radical derived from an active alcohol or enol of the formula R²OH;
R³, R⁴ and R^{4′} represent a hydrogen atom or a C₁ to C₂₀ linear or branched, saturated or unsaturated, radical, optionally substituted with one or more heteroatoms; or the R³, R⁴ and R^{4′}, when considered together with the carbon atoms to which they are bonded, can form aromatic or aliphatic monocyclic, bicyclic or tricyclic groups; and with the proviso that at least two of the Q moieties in formula (I) are not hydrogen atoms;
h) T represents a hydrogen or halide atom, a sulfate or sulfonate group, a C₁ to C₁₀ ester, alkyl, alcoholate or cyanoalkyl group, a carboxylic acid or a N(R⁵)₂ group or its corresponding C₁ to C₆ alkylated quaternary salts, R⁵ being a hydrogen atom or a C₁-C₁₅ alkyl, alkenyl or aromatic group, the group optionally containing in the main chain from 1 to 5 functional groups selected from the group consisting of ether, ester, ketone, amine, quaternary amines and amides;
i) M represents a dendritic core of zero to 7^{th} generation, a group of the formula A) or a “monomeric unit” of a polymeric chain, selected from the group consisting of the saccharides and the monomeric units of the formulae B) to G) and mixtures thereof: 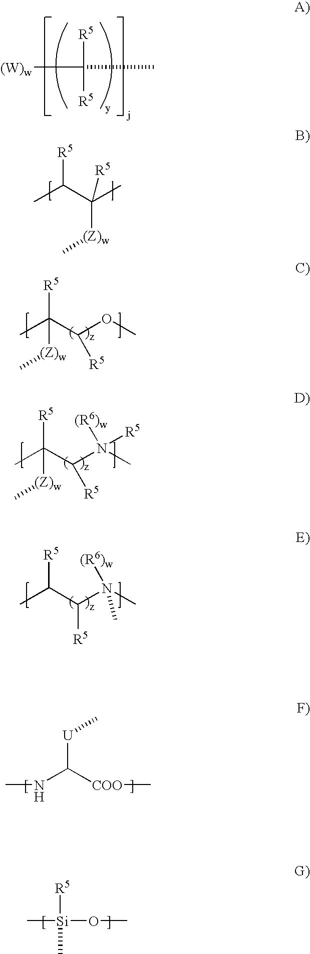
in which formulae A) to G) the hatched lines indicate the location of the bond between the group A) to G) and R¹, R⁵ is defined as previously;
w is equal ¹ or 0;
y represents an integer from 1 to 12;
j represents an integer from 2 to 4;
z represents an integer from 1 to 5;
W represents a nitrogen or carbon atom or a NR⁵, NR⁵₂, O, CO, OC(O)O, C(O)O, C(N)O or NC(O)N functional group;
R⁶ represents a hydrogen or oxygen atom or a C₁-C₅ alkyl or glycol group;
U represents a side chain of an amino acid; and
Z represents a functional group selected from the groups consisting of the functional groups of the formulae i) to x) and the branching units of formulae xi) to xiii) and mixtures thereof: 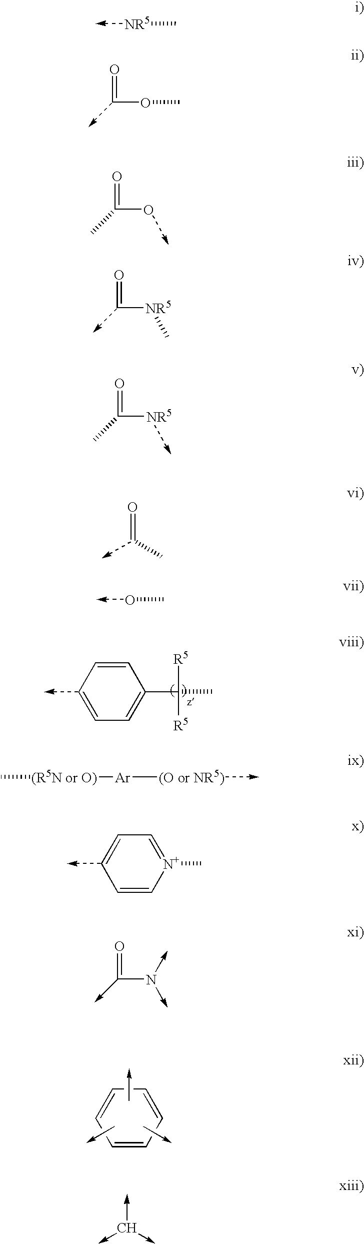
in which formulae the hatched lines being defined as previously, the dotted arrows indicating the location of the bond between the Z and the remaining part of the monomeric unit and the arrows indicating the location of the bond between the Z and either R¹ or the remaining part of the monomeric unit, R⁵ is defined as previously and z′ is an integer from 0 to 5; with the proviso that Z does not represent a group of formula i), iii), v), vii), and ix) if M represents a group of formula C) or D).

2. A compound according to claim 1, characterized in that in formula (I)
k, n, x, p and m are as defined in claim 1;
R represents a multivalent group derived from a polypropylene- or polyethylene-glycol having an average molecular weight comprised between 50 g/mol and 1200 g/mol, or a linear or branched multivalent C₁₋₁₂ alkyl group, optionally containing in the main chain 1 or 2 functional groups selected in the group consisting of carbonate, ester, ether, carbonyl or amine;
Q represents a group obtained from a phthalic or maleic derivative, optionally substituted, and an active alcohol or enol of the formula R²OH;
T represents a hydrogen atom, a N(R⁵)₂ group, a C₁-C₅ alkyl, alcoholate, cyanoalkyl or ester group, a sulfonate or sulfate group; and
M represents a dendritic core of zero to 5^{th} generation, a saccharide or a “building block” selected from the group consisting of the formulae A), wherein j=2 and W represents an oxygen atom or a NR⁵ or NR⁵₂ group, B), C), E) and F) or mixtures thereof, wherein w, y, z, R⁵, R⁶, U and Z are defined as in claim 1.

3. A compound according to claim 2, characterized in that M represents a group selected from the group consisting of:
a dendritic core of zero to 5^{th} generation selected from the group consisting of the polyalkylimine dendrimers, glycoamine dendrimers, amino acids dendrimers, mixed amino/ether dendrimers and mixed amino/amide dendrimers;
a saccharide derivative selected from the group consisting of glucose, glucosoamine, cellulose, amylose, mannuronic acid and guluronic acid;
a group of formula A) wherein j=2 and W represents an oxygen atom or a NR⁵ or NR⁵₂ group;
a group of formula B) representing an acrylic derivative or a styrene derivative;
a group of formula E) representing an ethyleneimine or propyleneimine derivative; and
a group of formula F) representing a lysine, a serine, a threonine or a tyrosine;
and in which formulae A), B) and E) the symbols R⁶, w, and y are as previously defined and R⁵ represents an hydrogen atom or a C₁-C₃ group.

4. A compound according to claim 1, characterized in that, in formula (I), Q represents a group obtained from a phthalic or maleic derivative, optionally substituted, and an active alcohol or enol of the formula R²OH; and the (T)ₚ-[M-((R¹)ₖ—(NH)ₙ)ₘ]ₓ-(T)ₚ moiety represents a group derived from one of the compounds selected in the group consisting of:
a polyamidoamine dendrimer
a polyalkylamine dendrimer;
a chitosan, a polyamino alginate or cellulose, a cyclodextrine or a starch derivative containing at least two NH₂ groups;
a polyalkyleneimine; and
a polylysine; and in which moiety (T)ₚ-[M-((R¹)ₖ—(NH)ₙ)ₘ]ₓ-(T)ₚ the indexes k, n, x, p and m are as previously defined.

5. A compound according to claim 1, characterized in that in formula (I)
k, n, x, p and m are as defined in claim 1;
R¹ represents a multivalent group derived from a polypropylene- or polyethylene-glycol having an average molecular weight comprised between 50 g/mol and 1200 g/mol, or a linear or branched multivalent C₁₋₁₂ alkyl group, optionally containing in the main chain 1 or 2 functional groups selected in the group consisting of carbonate, ester, ether, carbonyl or amine,
Q represents a group obtained from a phthalic or maleic derivative, optionally substituted, and an active alcohol or enol of the formula R²OH; and
the (T)ₚ-[M]ₓ-(T)ₚ moiety represents a group derived from one of the compounds selected from the group consisting of a polystyrene, a cross-linked polystyrene, an acrylic or methacrylic acid polymer, or an acrylic or methacrylic ester of a C₁ to C₄ alcohol.

6. A compound according to claim 1, characterized in that in formula (I)
k, n, x, p and m are as defined in claim 1;
R¹ represents a multivalent group derived from a polypropylene- or polyethylene-glycol having an average molecular weight comprised between 50 g/mol and 1200 g/mol, or a linear or branched multivalent C₁₋₁₂ alkyl group, optionally containing in the main chain 1 or 2 functional groups selected in the group consisting of carbonate, ester, ether, carbonyl or amine,
Q represents a group obtained from a phthalic or maleic derivative, optionally substituted, and an active alcohol or enol of the formula R²OH; and
the (T)ₚ-[M]ₓ-(T)ₚ moiety represents a natural fiber based on cellulose or an amino acid.

7. A compound obtainable by a process that comprises the following steps:
a) reacting a diacid or an anhydride with an active compound of formula R²OH to form a derivative containing an ester bond and a carboxylic acid function;
b) converting the carboxylic acid function obtained in step a) into an acyl chloride or fluoride or into a mixed anhydride;
c) reacting the derivative obtained in step b) with the primary amino function of a compound of formula T-[M-(R¹)ₖ—(NH₂)ₙ)ₘ]ₓ-T, as defined in claim 1; or alternatively
d) reacting the derivative obtained in step b) with the primary amino function of a monomeric precursor of the polymeric back-bone M, as defined in claim 1; and
e) polymerizing, according to any standard method, the compound obtained in step d).

8. The method of claim 7, wherein the diacid is phthalic, succinic, maleic or glutaric acid.

9. The method of claim 7, wherein the anhydride is phthalic, succinic, maleic or glutaric anhydride.

10. An active ingredient or a precursor capable of liberating an active alcohol, ketone or aldehyde or a mixture thereof, comprising a compound as defined in claim 1.

11. A perfumery, flavor, insect repellent or attractant, bactericide or fungicide composition, product or article comprising as an active ingredient a compound as defined in claim 1 together with one or more of an additional active ingredient, a solvent or an adjuvant.

12. A composition, product or article according to claim 11, characterized in that the residue of the compound after liberation of the active compound is inactive.

13. A composition, product or article according to claim 11, in the form of an after-shave lotion, a soap, a bath or shower gel, a shampoo or conditioner or other hair care product, a deodorant or air freshener, a cosmetic preparation, a hygiene product, a detergent or fabric softener or a cleaning product.

14. A process for intensifying or prolonging the diffusion effect of an active compound in a surface, characterized in that the surface is contacted with a compound of formula (I) as defined in claim 1.

15. A process according to claim 14, characterized in that the surface is a textile and the compound of formula (I) is contained in a detergent or a fabric softener that contacts the surface during a laundering step.
